(19) United States
(12) Patent Application Publication
(10) Pub. No.: US 2024/0422637 A1
(43) Pub. Date: Dec. 19, 2024

(54) REVERSE HANDOVER OPERATIONS

(71) Applicant: QUALCOMM Incorporated, San Diego, CA (US)

(72) Inventors: Naeem AKL, Bridgewater, NJ (US); Shankar KRISHNAN, San Diego, CA (US); Sherif ELAZZOUNI, San Diego, CA (US); Navid ABEDINI, Basking Ridge, NJ (US)

(21) Appl. No.: 18/336,912

(22) Filed: Jun. 16, 2023

(51) Int. Cl. H04W 36/08; H04W 36/00; H04W 36/36

(52) U.S. Cl. CPC H04W 36/08; H04W 36/0061; H04W 36/362

(57) ABSTRACT

Various aspects of the present disclosure generally relate to wireless communication. In some aspects, a user equipment (UE) may obtain, from a first network node via a source cell, a reverse handover command associated with a second handover operation for handing over the UE from a first target cell to a second target cell. The UE may perform a first handover operation to hand over the UE from the source cell to the first target cell. The UE may perform the second handover operation to hand over the UE from the first target cell to the second target cell. Numerous other aspects are described.

### INTRODUCTION

Aspects of the present disclosure generally relate to wireless communication and specifically relate to techniques and apparatuses for handover operations.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, system bandwidth and/or device transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies, massive multiple-input multiple-output (MIMO), disaggregated network architectures and network topology expansions, multiple-subscriber implementations, and/or high-precision positioning, among other examples. As the demand for mobile broadband access continues to increase, further improvements in NR may be implemented, and other radio access technologies such as 6G may be introduced to further advance mobile broadband evolution.

### SUMMARY

Some aspects described herein relate to a user equipment (UE) for wireless communication. The user equipment may include one or more memories and one or more processors coupled to the one or more memories. The one or more processors may be configured to obtain, from a first network node via a source cell, a reverse handover command associated with a second handover operation for handing over the UE from a first target cell to a second target cell. The one or more processors may be configured to perform a first handover operation to hand over the UE from the source cell to the first target cell. The one or more processors may be configured to perform the second handover operation to hand over the UE from the first target cell to the second target cell.

Some aspects described herein relate to a first network node for wireless communication. The first network node may include one or more memories and one or more processors coupled to the one or more memories. The one or more processors may be configured to provide, to a second network node, a first handover request message associated with a first handover operation for handing over a UE from a source cell to a first target cell, the first handover request message including a reverse handover indication associated with a second handover operation for handing over the UE from the first target cell to a second target cell. The one or more processors may be configured to obtain, from the UE, an access communication associated with the second handover operation.

Some aspects described herein relate to a second network node for wireless communication. The second network node may include one or more memories and one or more processors coupled to the one or more memories. The one or more processors may be configured to obtain, from a first network node, a first handover request message associated with a first handover operation for handing over a UE from a source cell to a first target cell, the first handover request message including a reverse handover indication associated with a second handover operation for handing over the UE from the first target cell to a second target cell. The one or more processors may be configured to obtain, from the UE, an access communication associated with the first handover operation.

Some aspects described herein relate to a method of wireless communication performed by a UE. The method may include obtaining, from a first network node via a source cell, a reverse handover command associated with a second handover operation for handing over the UE from a first target cell to a second target cell. The method May include performing a first handover operation to hand over the UE from the source cell to the first target cell. The method may include performing the second handover operation to hand over the UE from the first target cell to the second target cell.

Some aspects described herein relate to a method of wireless communication performed by a first network node. The method may include providing, to a second network node, a first handover request message associated with a first handover operation for handing over a UE from a source cell to a first target cell, the first handover request message including a reverse handover indication associated with a second handover operation for handing over the UE from the first target cell to a second target cell. The method may include obtaining, from the UE, an access communication associated with the second handover operation.

Some aspects described herein relate to a method of wireless communication performed by a second network node. The method may include obtaining, from a first network node, a first handover request message associated with a first handover operation for handing over a UE from a source cell to a first target cell, the first handover request message including a reverse handover indication associated with a second handover operation for handing over the UE from the first target cell to a second target cell. The method may include obtaining, from the UE, an access communication associated with the first handover operation.

Some aspects described herein relate to a non-transitory computer-readable medium that stores a set of instructions for wireless communication by a UE. The set of instructions, when executed by one or more processors of the UE, may cause the UE to obtain, from a first network node via a source cell, a reverse handover command associated with a second handover operation for handing over the UE from a first target cell to a second target cell. The set of instructions, when executed by one or more processors of the UE, may cause the UE to perform a first handover operation to hand over the UE from the source cell to the first target cell. The set of instructions, when executed by one or more processors of the UE, may cause the UE to perform the second handover operation to hand over the UE from the first target cell to the second target cell.

Some aspects described herein relate to a non-transitory computer-readable medium that stores a set of instructions for wireless communication by a first network node. The set of instructions, when executed by one or more processors of the first network node, may cause the first network node to provide, to a second network node, a first handover request message associated with a first handover operation for handing over a UE from a source cell to a first target cell, the first handover request message including a reverse handover indication associated with a second handover operation for handing over the UE from the first target cell to a second target cell. The set of instructions, when executed by one or more processors of the first network node, may cause the first network node to obtain, from the UE, an access communication associated with the second handover operation.

Some aspects described herein relate to a non-transitory computer-readable medium that stores a set of instructions for wireless communication by a second network node. The set of instructions, when executed by one or more processors of the second network node, may cause the second network node to obtain, from a first network node, a first handover request message associated with a first handover operation for handing over a UE from a source cell to a first target cell, the first handover request message including a reverse handover indication associated with a second handover operation for handing over the UE from the first target cell to a second target cell. The set of instructions, when executed by one or more processors of the second network node, may cause the second network node to obtain, from the UE, an access communication associated with the first handover operation.

Some aspects described herein relate to an apparatus for wireless communication. The apparatus may include means for obtaining, from a first network node via a source cell, a reverse handover command associated with a second handover operation for handing over the apparatus from a first target cell to a second target cell. The apparatus may include means for performing a first handover operation to hand over the apparatus from the source cell to the first target cell. The apparatus may include means for performing the second handover operation to hand over the apparatus from the first target cell to the second target cell.

Some aspects described herein relate to an apparatus for wireless communication. The apparatus may include means for providing, to a second network node, a first handover request message associated with a first handover operation for handing over a UE from a source cell to a first target cell, the first handover request message including a reverse handover indication associated with a second handover operation for handing over the UE from the first target cell to a second target cell. The apparatus may include means for obtaining, from the UE, an access communication associated with the second handover operation.

Some aspects described herein relate to an apparatus for wireless communication. The apparatus may include means for obtaining, from a first network node, a first handover request message associated with a first handover operation for handing over a UE from a source cell to a first target cell, the first handover request message including a reverse handover indication associated with a second handover operation for handing over the UE from the first target cell to a second target cell. The apparatus may include means for obtaining, from the UE, an access communication associated with the first handover operation.

Aspects generally include a method, apparatus, system, computer program product, non-transitory computer-readable medium, user equipment, base station, network node, network entity, wireless communication device, and/or processing system as substantially described with reference to and as illustrated by the drawings and specification.

The foregoing has broadly summarized some aspects of the present disclosure. Additional aspects and associated advantages will be described hereinafter. The disclosed aspects may be used as a basis for modifying or designing other aspects for carrying out the same purposes of the present disclosure. Such equivalent aspects do not depart from the scope of the appended claims. Characteristics of the aspects disclosed herein, both their organization and method of operation, together with associated advantages will be better understood from the following description when considered in connection with the accompanying drawings. Each of the drawings is provided for the purposes of illustration and description, and not as a definition of the limits of the claims.

### BRIEF DESCRIPTION OF THE DRAWINGS

The appended drawings illustrate some aspects of the present disclosure, but are not limiting of the scope of the present disclosure because the description may enable other aspects. The same reference numbers in different drawings may identify the same or similar elements.

FIG. 1 is a diagram illustrating an example of a wireless network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4A is a diagram illustrating an example of a handover procedure, in accordance with the present disclosure.

FIG. 4B is a diagram illustrating an example of a lower layer triggered mobility (LTM) procedure, in accordance with the present disclosure.

FIG. 5A is a diagram illustrating an example associated with reverse handover operations, in accordance with the present information.

FIG. 5B is a diagram illustrating another example associated with reverse handover operations, in accordance with the present information.

FIG. 6 is a diagram illustrating an example process performed, for example, by a UE, in accordance with the present disclosure.

FIG. 7 is a diagram illustrating an example process performed, for example, by a first network node, in accordance with the present disclosure.

FIG. 8 is a diagram illustrating an example process performed, for example, by a second network node, in accordance with the present disclosure.

FIG. 9 is a diagram of an example apparatus for wireless communication, in accordance with the present disclosure.

FIG. 10 is a diagram illustrating an example of a hardware implementation for an apparatus employing a processing system, in accordance with the present disclosure.

FIG. 11 is a diagram illustrating an example of an implementation of code and circuitry for an apparatus, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

### DETAILED DESCRIPTION

In some cases, a user equipment (UE) may be initially connected to (e.g., served on or by) a source cell. A network node that provides the source cell may determine that the network node may save energy by reducing a load on the source cell. To facilitate a switch, of the source cell, to a network energy savings (NES) mode, one or more UEs that are being served by the source cell may be handed over to another cell (referred to as a “target cell”). In some cases, the source cell and the target cell may be provided by the same network node and in other cases, the source cell and the target cell may be provided by different network nodes. In either case, the network node that provides the source cell may determine that reducing a network load on the source cell (e.g., by reducing the number of UEs connected to the source cell) may enable the network node to save energy resources. The NES mode may be a mode in which the load on the source cell is reduced and/or eliminated, thereby enabling the network node that provides the source cell to expend fewer energy resources (e.g., by deactivating associated antenna elements and/or transmitting fewer signals, among other examples).

However, in a UE mobility scenario, the handover may occur quickly, so as to not compromise the energy savings opportunity associated with the source cell. In some cases, a UE may be configured to handover from a source cell to a first target cell. For example, the network node providing the source cell may provide configuration information to the UE that configures the UE to perform a handover to the first target cell. The UE may be handed over to the first target cell (e.g., a connection between the UE and the first target cell may be established and the connection between the UE and the source cell may be removed). If, at some later time, the first target cell becomes unable to serve the UE efficiently (e.g., if the UE is no longer within a coverage area of the first target cell and/or the load on the first target cell becomes too large, among other examples), the UE may be handed over to another cell. For example, the UE and/or the network node that provides the first target cell may identify another cell to hand the UE over to. In some cases, due to the location of the UE and/or the load on the source cell or an additional cell associated with the network node providing the source cell, the source cell or the additional cell may be an appropriate second target cell to hand the UE over to. However, in some cases, the UE may only discover that the source cell or the additional cell is an appropriate second target cell through measurements associated with the source cell or the additional cell and/or other neighboring cells. Performance of the measurements may take time, reducing mobility of the UE. Additionally, in some cases, the source cell may be configured to enter the NES mode temporarily. Thus, a temporary handover of the UE to the first target cell may be sufficient to facilitate the NES mode of the source cell.

Some aspects described herein provide for reverse handover operations in which a UE is handed over, from a source cell provided by a network node to a first target cell and then is handed over to a second target cell. The second target cell may be the source cell or another cell associated with the network node that provides the source cell. In some aspects, the network node providing the source cell (which may be referred to as a “first network node”) may prepare, in conjunction with a second network node associated with a first target cell, for performing the reverse handover. In some aspects, the first network node and the second network node may be co-located or distributed. The UE may perform a first handover operation to switch service from the source cell to the first target cell and then perform a second handover operation to switch service to a second target cell, which may be the source cell or another serving cell associated with the first network node. In some aspects, the second handover operation (referred to as a “reverse handover operation”) may be triggered by the second target cell transitioning from an NES mode to a non-NES mode. In this way, various aspects described herein may facilitate opportunities for NES mode in cells without compromising mobility of UEs in the environment.

For example, in some aspects, the first network node and the second network node may coordinate to prepare for the second handover operation during preparation for the first handover operation. In some aspects, the first network node may provide a handover request handover request message to the second network node. The handover request message may be associated with a first handover operation to hand the UE over from a source cell to the first target cell. The handover request message may include a reverse handover indication associated with a second handover operation for handing over the UE from the first target cell to a second target cell. The second network node may provide, to the first network node, a handover request acknowledgment message. The handover request acknowledgment message may include an acknowledgement and acceptance of the second handover operation. In some aspects, the handover request acknowledgement message may include other preparation information such as, for example, a suggested admitted service time associated with connection between the UE and the first target cell. The first network node may provide configuration information to the UE. In some aspects, the configuration information may include, for example, a first configuration associated with the first target cell and a second configuration associated with the second target cell. The first configuration may include a first radio resource control (RRC) configuration and the second configuration may include a second RRC configuration. The first network node may provide a lower-layer trigger message to the UE. The lower-layer trigger message may include a layer 1 and/or layer 2 trigger message and may be associated with the first handover operation and the second handover operation. In some aspects, the lower-layer trigger message may include a lower layer triggered mobility (LTM) medium access control (MAC) control element (MAC CE). In some aspects, the lower-layer trigger message may include an indication of a minimum admitted service time associated with connection between the UE and the first target cell prior to performance of the second handover operation. In some aspects, the configuration information may include an indication of the minimum admitted service time.

The UE and the second network node may perform the first handover operation, to hand the UE over from a source cell to a first target cell. In some aspects, the UE may perform the first handover operation based on performing a first LTM handover operation and based on obtaining the lower-layer trigger message. The UE and the first network node may perform a reverse handover operation. For example, the reverse handover operation may be referred to as a second handover operation and may be performed to hand the UE over from the first target cell to the second target cell. In some aspects, the UE and the first network node may perform the second handover operation based on performing a second LTM handover operation and based on obtaining the lower-layer trigger message. In some aspects, the second handover operation may include a conditional handover (CHO), in which the second handover operation is performed based on a condition being satisfied (e.g., based on a signal measurement associated with the second target cell satisfying a threshold and/or a signal measurement associated with the first target cell satisfying a threshold) and the UE may maintain the CHO configuration after performing the first handover operation.

In some aspects, the first network node may provide a first handover request message that includes a reverse handover indication associated with a second handover operation for handing over the UE from the first target cell to the second target cell. After the UE connects to the first target cell, the second network node may trigger a UE handover to a second target cell associated with the first network node based on the reverse handover indication. In some aspects, the reverse handover indication may include a duration indication indicative of a duration associated with an admitted service time associated with a connection between the UE and the first target cell prior to performance of the second handover operation. In some aspects, the reverse handover indication may include a timing indication indicative of a time range within which the second handover operation is to be performed. For example, in some aspects, the duration may correspond to an NES mode associated with the source cell. For example, in some aspects, the first network node may activate an NES mode based on the duration (e.g., while the UE is connected to the first target cell). For example, the first network node may defer transition of the source cell to the NES mode based on whether the second network node admits the UE. If the UE is admitted for a duration, the first network node may plan the NES mode for the source cell based at least in part on the admitted duration.

In some aspects, the second network node may provide a handover request acknowledgment message to accept the first handover operation. In some aspects, the second network node may accept the first handover operation based on the handover request message including the reverse handover indication. In some aspects, the handover request message may include a suggested admitted service time associated with a connection between the UE and the first target cell. In some aspects, the first network node may provide a modification request message to the second network node. The modification request message may indicate at least one of a modification of an admitted service time associated with a connection between the UE and the first target cell, or a cancellation of the second handover operation.

In implementations in which the second network node is implemented as a control unit (CU) and one or more distributed units (DUs), the CU may forward the reverse handover indication to the DU. The DU may admit the UE based on the indication and respond to the CU, which may acknowledge the first handover request message via an Xn protocol message. The first handover operation may be executed. The first network node may provide a second request message to the second network node to request the reverse handover. To facilitate the second handover operation, the second request message may indicate the UE identifier (ID). For example, in some aspects, the first request message may include the UE ID and at least one of the first handover request message or a context release message may include an indication to maintain the UE ID. In some aspects, the second request message may indicate a cell ID corresponding to the second target cell.

In some aspects, the first network node may provide, to the UE, a reverse handover command associated with the second handover operation. In some aspects, the first network node may provide, to the UE, configuration information including a first configuration associated with the first target cell and a second configuration associated with the second target cell. The UE and the first network node may perform the second handover operation. In some cases, intra-CU mobility may be supported. For example, the UE may be configured for LTM operations, in which the first network node is a first DU and the second network node is a second DU. The UE may be configured with a subsequent LTM handover operation configuration to support the second handover operation.

In some aspects, the UE may be configured with CHO to the second target cell while on the source cell. The UE may receive a CHO configuration for handover to the second target cell via RRC signaling from the first network node. The first handover operation may be prepared between the first and second network nodes and the handover command for the first handover operation may be provided to the UE. The UE may execute the first handover operation but may not release the CHO configuration to the second target cell. The UE may retain the CHO configuration to the second target cell based on an implicit determination that the UE was configured with the CHO configuration to the source cell while served on the source cell, or the UE may retain the CHO configuration to the second target cell based on a flag in RRC from the first network node. The UE may receive a condition configuration associated with triggering the execution of the reverse CHO. The condition configuration may include channel conditions associated with the new source link and/or target link. The condition configuration may include a timer value, and upon timer expiry the UE may be triggered to execute the reverse CHO. The time value may indicate absolute time or a countdown with respect to a reference that could be the time of CHO configuration for the reverse handover or the time of handover completion of the forward handover. The time value may be associated with the NES mode of operation of the source cell of the forward handover. The first network node may provide the UE with the CHO configuration for the second handover operation along with the handover command (received from the second network node) in the same message. A flag may be included to differentiate which RRC configuration is for the first handover operation and which is for the second handover operation.

Various aspects of the disclosure are described hereinafter with reference to the accompanying drawings. However, this disclosure may be embodied in many different forms and is not to be construed as limited to any specific aspect presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using any quantity of the aspects set forth herein. In addition, the scope of the disclosure is intended to cover an apparatus or method that is practiced using another structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

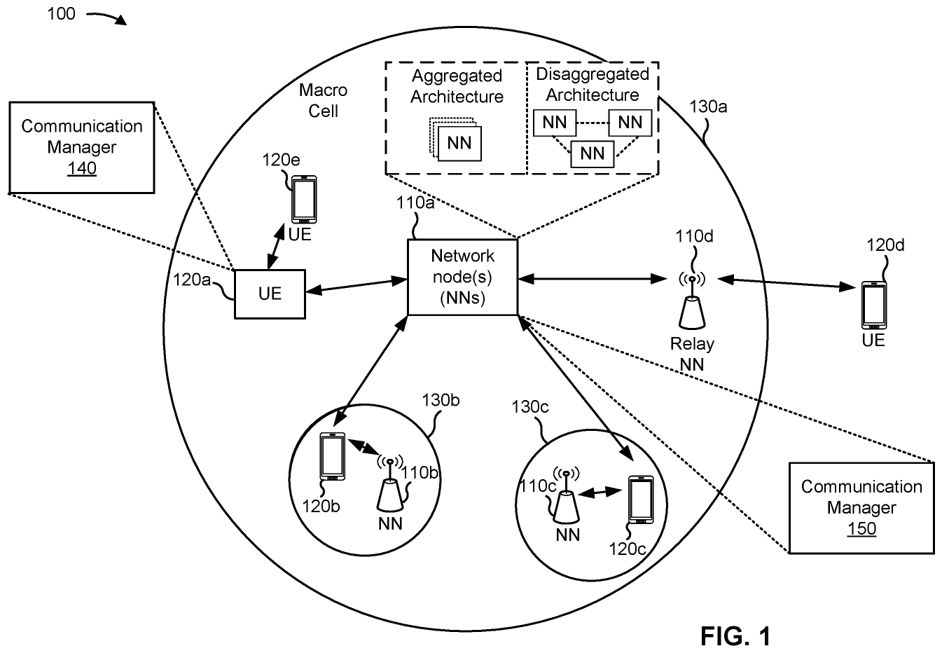

FIG. 1 is a diagram illustrating an example of a wireless network 100 in accordance with the present disclosure. The wireless network 100 may be or may include elements of a 5G (or NR) network or a 6G network, among other examples. The wireless network 100 may include multiple network nodes 110 (also referred to as network entities), shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

A network node 110 may include one or more devices that enable communication between a UE 120 and one or more components of the wireless network 100. A network node 110 may be, may include, or may be referred to as an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or another type of device or devices included in a radio access network (RAN).

A network node 110 may be a single physical node or may be two or more physical nodes. For example, a network node 110 may be a device or system that implements part of a radio protocol stack, a device or system that implements a full protocol stack (such as a full gNB protocol stack), or a collection of devices or systems that collectively implement the full protocol stack. For example, and as shown, a network node 110 may be an aggregated network node, meaning that the network node 110 may use a radio protocol stack that is physically and logically integrated within a single node in the wireless network 100. For example, an aggregated network node 110 may consist of a single standalone base station or a single TRP that uses a full radio protocol stack to enable or facilitate communication between a UE 120 and a core network of the wireless network 100.

Alternatively, and as also shown, a network node 110 may be a disaggregated network node (sometimes referred to as a disaggregated base station), meaning that the network node 110 may use a protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN), such as the network configuration sponsored by the O-RAN Alliance, or in a virtualized radio access network (vRAN), also known as a cloud radio access network (C-RAN), to facilitate scaling of communication systems by separating base station functionality into multiple units that can be individually deployed.

The network nodes 110 of the wireless network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more high physical (PHY) layers depending, at least in part, on a functional split, such as a functional split defined by the Third Generation Partnership Project (3GPP). In some examples, a DU may host one or more low PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or low PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a network node 110 may include a combination of one or more CUs, one or more DUs, one or more RUs, one or more IAB nodes, one or more Near-Real Time (Near-RT) RAN Intelligent Controllers (RICs), and/or one or more Non-Real Time (Non-RT) RICs in the wireless network 100. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as within a cloud deployment.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may include one or more control channels and one or more data channels. An uplink control channel may be used to transmit uplink control information (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

In some examples, the wireless network 100 may be configured for half-duplex operation and/or full-duplex operation. In half-duplex operation, a network node 110 and/or a UE 120 may only transmit or receive communications during particular time periods, such as during particular slots, symbols, or other time periods. Half-duplex operation may involve time-division duplexing (TDD), in which transmissions of the network node 110 and transmissions of the UE 120 do not occur in the same time periods (that is, the transmissions do not overlap in time). For example, in half-duplex operation, a wireless communication device may perform only one of transmission or reception in a particular time period. In full-duplex operation, a wireless communication device (such as the network node 110 and/or the UE 120) may transmit and receive communications concurrently (for example, in the same time period). In some examples, full-duplex operation may involve frequency-division duplexing (FDD), in which transmissions of the network node 110 are performed on a first frequency and transmissions of the UE 120 are performed on a second frequency different from the first carrier. In FDD, transmissions of the network node 110 and transmissions of the UE 120 can be performed concurrently. In some examples, a UE 120 may communicate with two network nodes 110 in a configuration that may be referred to as a multi-TRP (mTRP) configuration. In some examples, full-duplex operation may be enabled for a UE 120 but not for a network node 110. For example, a UE 120 may simultaneously transmit an UL transmission to a first network node 110 and receive a DL transmission from a second network node 110 in the same time instance. In some other examples, full-duplex operation may be enabled for a network node 110 but not for a UE 120. For example, a network node 110 may simultaneously transmit a DL transmission to a first UE 120 and receive an UL transmission from a second UE 120 in the same time instance. In some examples, full-duplex operation may be enabled for both a network node 110 and a UE 120. Full-duplex operation increases the capacity of the network and the radio access link.

In some examples, the UE 120 and the network node 110 may perform MIMO communication. “MIMO” generally refers to transmitting and receiving multiple data signals (such as multiple layers or multiple data streams) simultaneously over a radio channel. MIMO may exploit multipath propagation. MIMO may be implemented using spatial processing referred to as precoding, or MIMO may be implemented using spatial multiplexing. In some examples, MIMO may support simultaneous transmission to multiple receivers, referred to as multi-user MIMO (MU-MIMO). Some radio access technologies (RATs) may employ advanced MIMO techniques, such as multiple TRP operation (including redundant transmission or reception on multiple TRPs), reciprocity in the time domain or the frequency domain, single-frequency-network (SFN) transmission, or non-coherent joint transmission (NC-JT).

As described above, in some aspects, the wireless network 100 may be, may include, or may be included in an IAB network. In an IAB network, at least one network node 110 may be an anchor network node that communicates with a core network via a wired backhaul link, such as a fiber connection. An anchor network node 110 may also be referred to as an IAB donor (or IAB-donor), a central entity, and/or a CU, among other examples. An IAB network may include one or more non-anchor network nodes 110, sometimes referred to as relay network nodes or IAB nodes (or IAB-nodes). The non-anchor network node 110 may communicate directly with or indirectly with (for example, via one or more non-anchor network nodes) the anchor network node 110 via one or more backhaul links to form a backhaul path to the core network for carrying backhaul traffic. In various deployments, the backhaul links may be wireless links. Anchor network nodes 110 and/or non-anchor network nodes 110 may also communicate directly with one or more UEs 120 via access links, which may be wireless links for carrying access traffic.

As described above, an IAB network includes an IAB donor that may connect to a core network via a wired connection (for example, a wireline backhaul). For example, an Ng interface of an IAB donor may terminate at a core network. Additionally, or alternatively, an IAB donor may connect to one or more devices of the core network that provide a core access and mobility management function (AMF). As described above, an IAB donor may include a CU, which may perform access node controller (ANC) functions and/or AMF functions. The CU may configure a DU of the IAB donor and/or may configure one or more IAB nodes (for example, a mobile termination (MT) function and/or a DU function of an IAB node) that connect to the core network via the IAB donor. A link between an IAB donor and an IAB node or between two IAB nodes may also be referred to as a backhaul link. In some examples, a backhaul link between an IAB donor and an IAB node or between two IAB nodes may be a wireless backhaul link that provides an IAB node with radio access to a core network via an IAB donor, and optionally via one or more other IAB nodes. Thus, a CU of an IAB donor may control and/or configure the entire IAB network (or a portion thereof) that connects to the core network via the IAB donor, such as by using control messages and/or configuration messages (for example, an RRC configuration message or an F1 application protocol (F1AP) message). Access links may facilitate communications between a UE 120 and an IAB donor or between a UE 120 and an IAB node. For example, network resources for wireless communications (such as time resources, frequency resources, and/or spatial resources) may be shared between access links and backhaul links. A backhaul link May be a primary backhaul link or a secondary backhaul link (for example, a backup backhaul link). In some aspects, a secondary backhaul link may be used if a primary backhaul link fails, becomes congested, and/or becomes overloaded, among other examples.

When a first IAB node controls and/or schedules communications for a second IAB node (for example, when the first IAB node provides DU functions for the MT functions of the second IAB node), the first IAB node may be referred to as a parent IAB node of the second IAB node, and the second IAB node may be referred to as a child IAB node of the first IAB node. A child IAB node of the second IAB node may be referred to as a grandchild IAB node of the first IAB node. Thus, a DU function of a parent IAB node may control and/or schedule communications for child IAB nodes of the parent IAB node. In some examples, a DU function may exercise limited control over communications of a grandchild node, such as via indication of soft resources or restricted beams at a child node associated with the grandchild node. In some examples, in an IAB network, a DU may be referred to as a scheduling node or a scheduling component, and an MT may be referred to as a scheduled node or a scheduled component. A parent IAB node may be an IAB donor or an IAB node, and a child IAB node may be an IAB node or a UE 120. Communications of an MT function of a child IAB node may be controlled and/or scheduled by a parent IAB node of the child IAB node.

A network node 110 that relays communications may be referred to as a relay station, a relay network node, or a relay. A relay station may receive a transmission of data from an upstream station (for example, a network node 110 or a UE 120) and send a transmission of the data to a downstream station (for example, a UE 120 or a network node 110). In this case, the wireless network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

In some examples, a relay station may include an electromagnetic radiation reflective relay network node 110 that can be used to relay signals from a first network node 110 to a second network node 110 or a UE 120. The electromagnetic radiation reflective relay network node 110 can include, for example, a radio frequency reflection array configured to perform radio frequency reflection services. The electromagnetic radiation reflective relay network node 110 can be, for example, a reconfigurable intelligent surface (RIS) (which also can be referred to as an intelligent reflective surface (IRS)).

The UEs 120 may be physically dispersed throughout the wireless network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 may include or may be included in a housing that houses components associated with the UE 120, such as one or more processor components and/or one or more memory components. One or more of the processor components may be coupled with one or more of the memory components and/or other components. For example, the processor components (for example, one or more processors) and the memory components (for example, one or more memories) may be operatively coupled, communicatively coupled, electronically coupled, or electrically coupled with one another.

Some UEs 120 may be considered machine-type communication (MTC) or evolved or enhanced machine-type communication (eMTC) UEs (or further enhanced eMTC (feMTC), or enhanced feMTC (efeMTC), or further evolutions thereof, all of which may be simply referred to as “MTC”). An MTC UE may be, may include, or may be included in or coupled with a robot, an unmanned aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless network 100).

Some UEs 120 may be classified according to different categories in association with different complexities and/or different capabilities. UEs 120 in a first category may facilitate massive IoT in the wireless network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, a UE 120 in the third category (a RedCap UE) may support lower latency communication than a UE 120 in the first category (an NB-IoT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IoT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IoT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements (such as parameters specified by Section 4.2.21 of 3GPP Technical Specification 38.306, Release 17) but not second device or performance requirements (such as parameters specified for NR UEs 120 other than UEs 120 of the third category, which may be defined by parameters specified by Section 4 of 3GPP Technical Specification 38.306, Release 17), while a UE 120 of the second category (a mission-critical IoT UE or a premium UE) may have capabilities that satisfy the second device or performance requirements (and also the first device or performance requirements, in some examples). For example, a UE 120 of the third category may support a lower maximum modulation and coding scheme (MCS) (for example, a modulation scheme such as quadrature phase shift keying (QPSK)) than an MCS supported by a UE 120 of the second category (for example, a modulation scheme such as 256-quadrature amplitude modulation (QAM)). As another example, a UE of the third category may support a lower maximum transmit power than a maximum transmit power of a UE of the second category. As another example, a UE 120 of the third category may have a less advanced beamforming capability than a beamforming capability of a UE 120 of the second category (for example, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum BWP as a UE 120 of the second category.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may communicate using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless network 100. In some other deployments and configurations, a UE 120 (instead of a network node 110) may perform, or collaborate or negotiate with one or more other UEs to perform, scheduling operations, resource selection operations, and/or other operations for sidelink communications.

Downlink and uplink resources may include time domain resources (frames, subframes, slots, and/or symbols), frequency domain resources (frequency bands, frequency carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a downlink control information (DCI) configuration to the one or more UEs 120) and/or reconfigured, which means that a BWP can be adjusted in real-time (or near-real-time) based on changing network conditions in the wireless network 100 and/or based on the specific requirements of the one or more UEs 120. This enables more efficient use of the available frequency domain resources in the wireless network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span a set of consecutive CRBs. Each BWP may be associated with its own numerology (indicating a sub-carrier spacing (SCS) and cyclic prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

As indicated above, a network node 110 may be a terrestrial network node 110 (for example, a terrestrial base station or entity of a disaggregated base station) or an NTN network node 110. For example, the wireless network 100 may include one or more NTN deployments including a non-terrestrial network node, an NTN network node 110, and/or a relay station. In some examples, a relay station in an NTN deployment may be referred to as a “non-terrestrial relay station.” An NTN may facilitate access to the wireless network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless network 100 using NTN communication. The other entities may include UEs 120, other NTN network nodes 110 in the one or more NTN deployments, other types of network nodes 110 (for example, stationary, terrestrial, and/or ground-based network nodes), relay stations, and/or one or more components and/or devices included in or coupled with a core network of the wireless network 100. For example, an NTN network node 110 may communicate with a UE 120 via a service link (for example, where the service link includes an access link). Additionally or alternatively, an NTN network node 110 may communicate with a gateway (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). An NTN deployment may be transparent (for example, where the NTN network node 110 operates in a similar manner as a repeater or relay and/or where an access link does not terminate at the NTN network node 110) or regenerative (for example, where the NTN network node 110 regenerates a signal and/or where an access link terminates at the NTN network node 110).

In some examples, a UE 120 may implement power saving features, such as for UEs 120 in an RRC connected mode, an RRC idle mode, or an RRC inactive mode. Power saving features may include, for example, relaxed radio resource monitoring (such as for devices operating in low mobility or in good radio conditions), discontinuous reception (DRX), reduced PDCCH monitoring during active times, and/or power-efficient paging reception.

A UE 120 may operate in association with a DRX configuration (for example, indicated to the UE 120 by a network node 110). DRX operation may enable the UE 120 to enter a sleep mode at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state, and one or more durations during which the UE 120 may operate in an inactive state, which may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. Conversely, if the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

The network nodes 110 and the UEs 120 of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different from the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

In some aspects, a UE (e.g., the UE 120) may include a communication manager 140. As described in more detail elsewhere herein, the communication manager 140 may obtain, from a first network node via a source cell, a reverse handover command associated with a second handover operation for handing over the UE from a first target cell to a second target cell; perform a first handover operation to hand over the UE from the source cell to the first target cell; and perform the second handover operation to hand over the UE from the first target cell to the second target cell. Additionally, or alternatively, the communication manager 140 may perform one or more other operations described herein.

In some aspects, a first network node (e.g., the network node 110) may include a communication manager 150. As described in more detail elsewhere herein, the communication manager 150 may provide, to a second network node, a first handover request message associated with a first handover operation for handing over a UE from a source cell to a first target cell, the first handover request message including a reverse handover indication associated with a second handover operation for handing over the UE from the first target cell to a second target cell; and obtain, from the UE, an access communication associated with the second handover operation. Additionally, or alternatively, the communication manager 150 may perform one or more other operations described herein.

In some aspects, a second network node (e.g., the network node 110) may include a communication manager 150. As described in more detail elsewhere herein, the communication manager 150 may obtain, from a first network node, a first handover request message associated with a first handover operation for handing over a user equipment (UE) from a source cell to a first target cell, the first handover request message including a reverse handover indication associated with a second handover operation for handing over the UE from the first target cell to a second target cell; and obtain, from the UE, an access communication associated with the first handover operation. Additionally, or alternatively, the communication manager 150 may perform one or more other operations described herein.

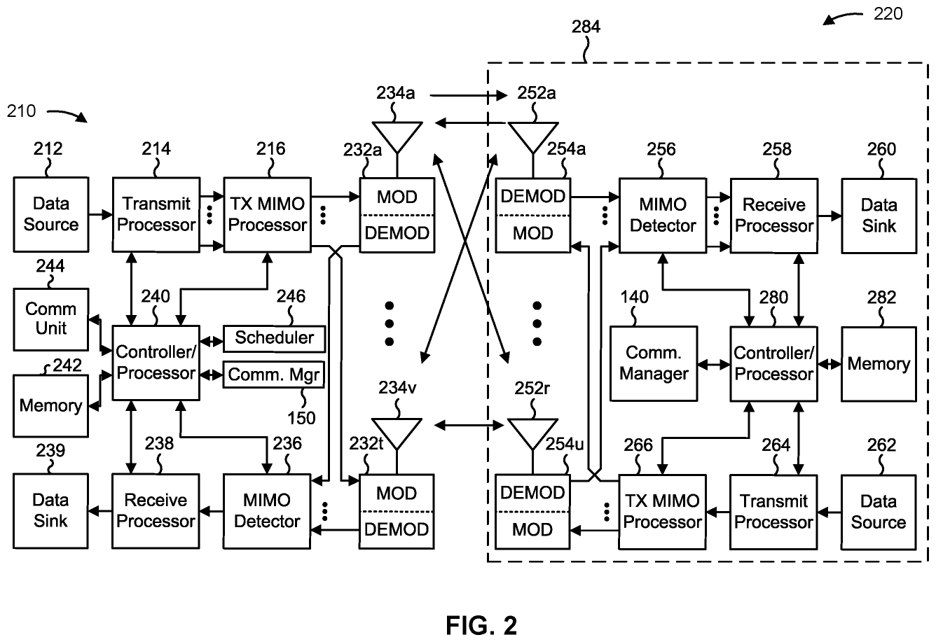

FIG. 2 is a diagram illustrating an example network node 210 in communication with an example UE 220 in a wireless network in accordance with the present disclosure. The network node 210 of FIG. 2 may be an example of the network node 110 described with reference to FIG. 1. Similarly, the UE 220 may be an example of the UE 120 described with reference to FIG. 1.

As shown in FIG. 2, the network node 210 may include a data source 212, a transmit processor 214, a transmit (TX) multiple-input multiple-output (MIMO) processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150 among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 210. The transceiver may be under control of and used by a processor, such as the controller/processor 240, and in some aspects in conjunction with processor-readable code stored in the memory 242, to perform aspects of the methods, processes, and/or operations described herein. In some aspects, the network node 210 may include one or more interfaces, communication components, and/or other components that facilitate communication with the UE 220 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 210 may include transmit processor 214, TX MIMO processor 216, MIMO detector 236, receive processor 238, and/or controller/processor 240. Similarly, one or more processors of the UE 220 may include MIMO detector 256, receive processor 258, transmit processor 264, TX MIMO processor 266, and/or controller/processor 280. As used herein, “processor,” “controller,” or “controller/processor” can refer to a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof. A general purpose processor may be a microprocessor or any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

In some aspects, a single processor may perform all of the operations described as being performed by the one or more processors. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

For downlink communication from the network node 210 to the UE 220, the transmit processor 214 may receive data (“downlink data”) intended for the UE 220 (or a set of UEs that includes the UE 220) from the data source 212 (such as a data pipeline or a data queue). In some examples, the transmit processor 214 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 210 may use the scheduler 246 to schedule one or more UEs 220 for downlink or uplink communications. In some aspects, the scheduler 246 may use DCI to dynamically schedule DL transmissions to the UE 220 and/or UL transmissions from the UE 220. In some examples, the scheduler 246 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 214, the TX MIMO processor 216, the modem 232, the antenna 234, the MIMO detector 236, the receive processor 238, and/or the controller/processor 240 may be included in an RF chain of the network node 210. An RF chain may include filters, mixers, oscillators, amplifiers, analog-to-digital converters (ADCs), and/or other devices that convert between an analog signal (such as for transmission or reception via an air interface) and a digital signal (such as for processing by one or more processors of the network node 210). In some aspects, the RF chain may be or may be included in a transceiver of the network node 210.

In some examples, the network node 210 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 210 may use the communication unit 244 to transmit and/or receive data associated with the UE 220 or to perform network control signaling, among other examples. The communication unit 244 may include a transceiver and/or an interface, such as a network interface.

The UE 220 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 220 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 220. The transceiver may be under control of and used by a processor, such as the controller/processor 280, and in some aspects in conjunction with processor-readable code stored in the memory 282, to perform aspects of the methods, processes, or operations described herein. In some aspects, the UE 220 may include another interface, another communication component, and/or another component that facilitates communication with the network node 210 and/or another UE 220.

For downlink communication from the network node 210 to the UE 220, the set of antennas 252 may receive the downlink communications or signals from the network node 210 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 220 to the data sink 260 (such as a data pipeline, a data queue, and/or an application executed on the UE 220), and may provide decoded control information and system information to the controller/processor 280.

For uplink communication from the UE 220 to the network node 210, the transmit processor 264 may receive and process data (“uplink data”) from a data source 262 (such as a data pipeline, a data queue, and/or an application executed on the UE 220) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 210 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 220 by the network node 210.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals (for example, R uplink signals) via the corresponding set of antennas 252. An uplink signal may include an uplink control information (UCI) communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 220) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 110 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

The network node 210 may provide the UE 220 with a configuration of transmission configuration indicator (TCI) states that indicate or correspond to beams that may be used by the UE 220, such as for receiving one or more communications via a physical channel. For example, the network node 210 may indicate (for example, using DCI) an activated TCI state to the UE 220, which the UE 220 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or a sounding reference signal (SRS) set ID, among other examples. A TCI state information element (sometimes referred to as a TCI state herein) may indicate particular information associated with a beam. For example, the TCI state information element may indicate a TCI state identification (for example, a tci-StateII)), a quasi-co-location (QCL) type (for example, a qcl-Type1, qcl-Type2, qcl-TypeA, qcl-TypeB, qcl-TypeC, or a qel-TypeD), among other examples), a cell identification (for example, a ServCellIndex), a bandwidth part identification (bwp-Id), or a reference signal identification, such as a CSI-RS identification (for example, an NZP-CSI-RS-Resourceld or an SSB-Index, among other examples). Spatial relation information may similarly indicate information associated with an uplink beam. The beam indication may be a joint or separate DL/UL beam indication in a unified TCI framework. In a unified TCI framework, the network may support common TCI state ID update and activation, which may provide common QCL and/or common UL transmission spatial filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some examples, the network may support a layer 1 (L1)-based beam indication using at least UE-specific (unicast) DCI to indicate joint or separate DL/UL beam indications that may be selected from active TCI states. In some examples, DCI formats 1_1 and/or 1_2 may be used for beam indication. The network node 210 may include a support mechanism for the UE 220 to acknowledge successful decoding of a beam indication. For example, the acknowledgment/negative acknowledgment of the PDSCH scheduled by the DCI carrying the beam indication may also be used as an acknowledgement for the DCI.

Further efficiencies in throughput, signal strength, and/or other signal properties may be achieved through beam refinement. For example, the network node 210 may be capable of communicating with the UE 220 using beams of various beam widths. For example, the network node 210 may be configured to utilize a wider beam to communicate with the UE 220 when the UE 220 is in motion because wider coverage may increase the likelihood that the UE 220 remains in coverage of the network node 210 while moving. Conversely, the network node 220 may use a narrower beam to communicate with the UE 220 when the UE 220 is stationary because the network node 210 can reliably focus coverage on the UE 220 with low or minimal likelihood of the UE 220 moving out of the coverage area of the network node 210. In some examples, to select a particular beam for communication with a UE 220, the network node 210 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 220 may measure the RSRP or the signal-to-interference-plus-noise ratio (SINR) on each of the beams and transmit a beam measurement report (for example, an L1 measurement report) to the network node 210 indicating the RSRP or SINR associated with each of one or more of the measured beams. The network node 210 may then select the particular beam for communication with the UE 220 based on the L1 measurement report. In some other examples, when there is channel reciprocity between the uplink and the downlink, the network node 210 may derive the particular beam to communicate with the UE 220 (for example, on both the uplink and downlink) based on uplink measurements of one or more uplink reference signals, such as an SRS, transmitted by the UE 220.

One enhancement for multi-beam operation at higher carrier frequencies is facilitation of efficient (for example, low latency and low overhead) downlink and/or uplink beam management operations to support higher Layer 1 and/or Layer 2 (L1/L2)-centric inter-cell mobility. L1 and/or L2 signaling may be referred to as “lower layer” signaling and may be used to activate and/or deactivate candidate cells in a set of cells configured for L1/L2 mobility and/or to provide reference signals for measurement by the UE 220, by which the UE 220 may select a candidate beam as a target beam for a lower layer handover operation. Accordingly, one goal for L1/L2-centric inter-cell mobility is to enable a UE to perform a cell switch via dynamic control signaling at lower layers (for example, DCI for L1 signaling or a medium access control (MAC) control element (MAC-CE) for L2 signaling), rather than semi-static Layer 3 (L3) RRC signaling, in order to reduce latency, reduce overhead, and/or otherwise increase efficiency of the cell switch.

In some examples, for a UE 220, UL transmission may be performed using one antenna panel, and DL reception may be performed using another antenna panel. In some examples, full-duplex communication may be conditional on a beam separation of the UL beam and DL beam at respective antenna panels. Utilizing full-duplex communication may provide a reduction in latency, such that it may be possible to receive a DL signal in UL-only slots, which may enable latency savings. In addition, full-duplex communication may enhance spectrum efficiency per cell or per UE 220, and may enable more efficient utilization of resources. Beam separation of the UL and DL beams assists in limiting or reducing self-interference that may occur during full duplex communication. UL and DL beams that are separated on their respective antenna panels may provide reliable full duplex communication by minimizing or reducing self-interference.

A full-duplex UE 220 may perform a self-interference measurement (SIM) procedure to identify self-interference from transmissions of the full-duplex UE 220. A full-duplex network node 210 also may perform a SIM procedure to identify self-interference from transmissions of the full-duplex network node 210. The UE 220 may provide a measurement report to the network node 210 to indicate results of the UE SIM. The network node 210 may select pairs of beams (referred to herein as “beam pairs”) for the UE 220 (“UE beam pairs”) and the network node 210 (“network node beam pairs”) to use during full-duplex communications. A beam pair generally includes a receive (Rx) beam and a transmit (Tx) beam, such as a DL beam and an UL beam, respectively, for the UE 220, and similarly, an UL beam and a DL beam, respectively, for the network node 210.

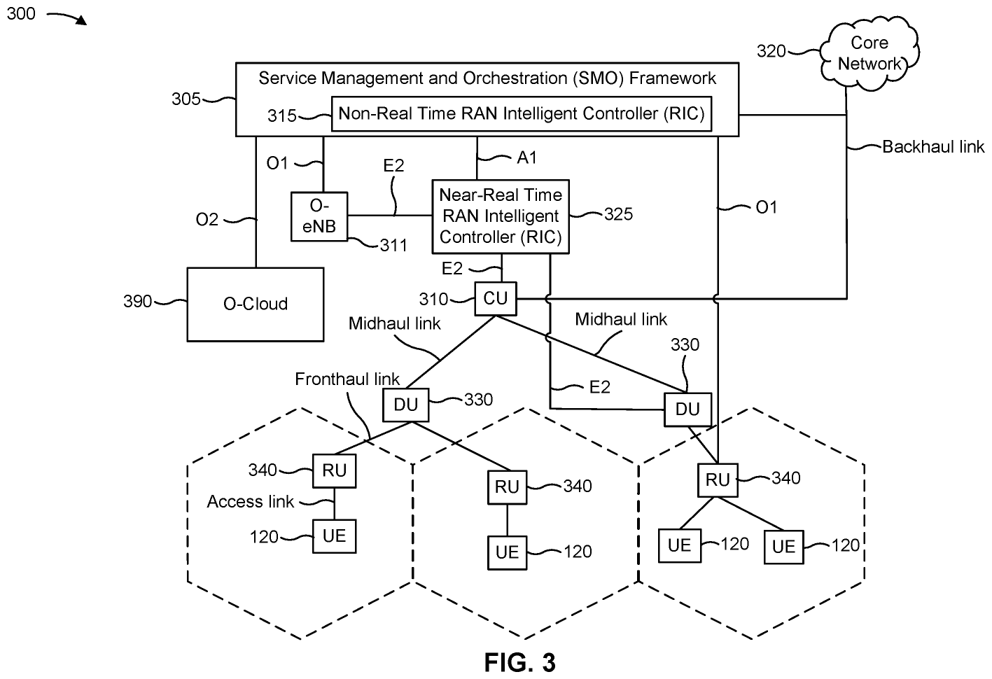

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110 or one or more network nodes 210). The disaggregated base station architecture 300 may include a CU 310 that can communicate directly with a core network 320 via a backhaul link, or that can communicate indirectly with the core network 320 via one or more disaggregated control units, such as a Near-RT RIC 325 (for example, via an E2 link) and/or a Non-RT RIC 315 associated with a Service Management and Orchestration (SMO) Framework 305. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 325, the Non-RT RICs 315, and the SMO Framework 305, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 305 may support RAN deployment and provisioning of non-virtualized and virtualized network elements. For non-virtualized network elements, the SMO Framework 305 may support the deployment of dedicated physical resources for RAN coverage requirements, which may be managed via an operations and maintenance interface, such as an O1 interface. For virtualized network elements, the SMO Framework 305 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 315, and/or a Near-RT RIC 325. In some aspects, the SMO Framework 305 may communicate with a hardware aspect of a 4G RAN, a 5G NR RAN, and/or a 6G RAN, such as an open eNB (O-eNB) 311, via an O1 interface. Additionally or alternatively, the SMO Framework 305 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 315 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 325. The Non-RT RIC 315 may be coupled to or may communicate with (such as via an A1 interface) the Near-RT RIC 325. The Near-RT RIC 325 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 325.

In some aspects, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may tune RAN behavior or performance. For example, the Non-RT RIC 315 may monitor long-term trends and patterns for performance and may employ AI/ML models to perform corrective actions via the SMO Framework 305 (such as reconfiguration via an O1 interface) or via creation of RAN management policies (such as A1 interface policies).

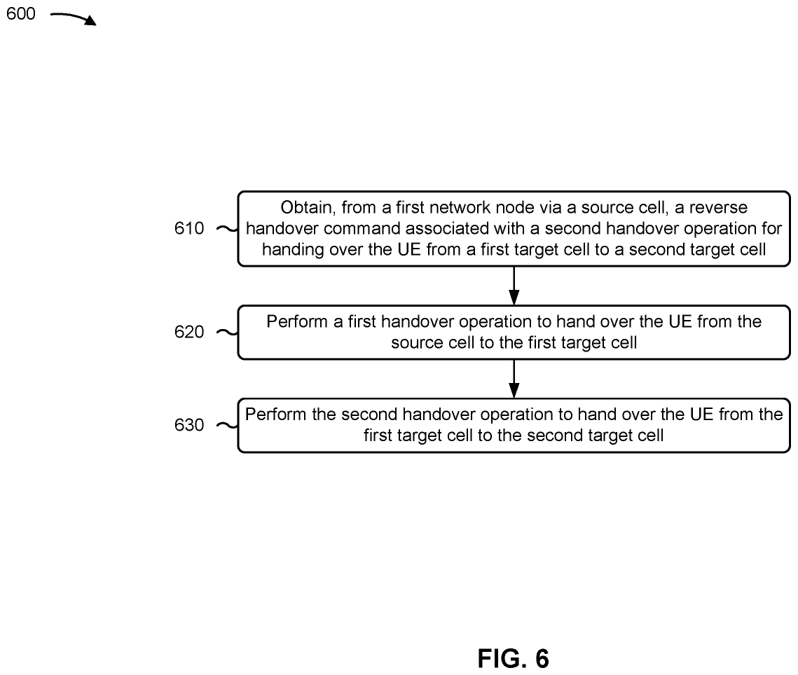

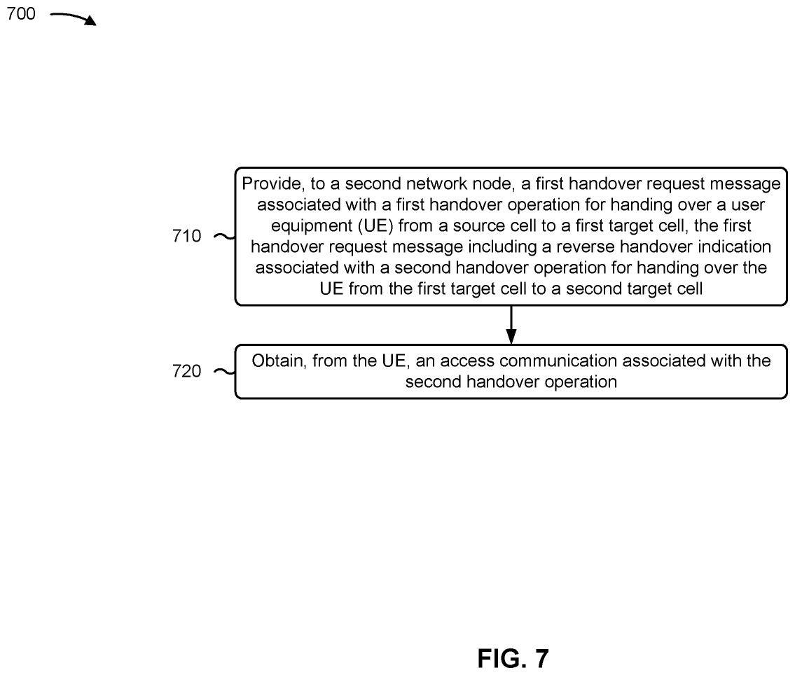

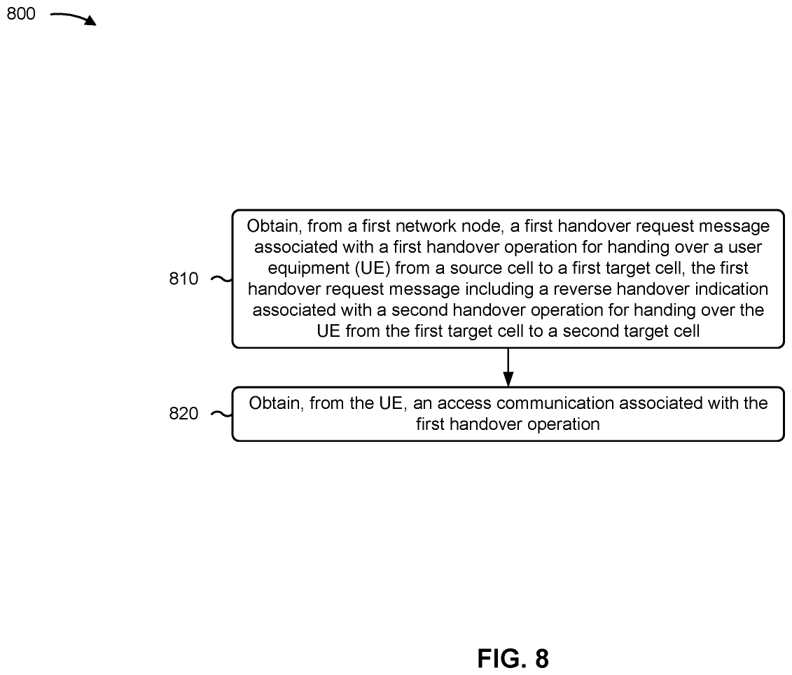

The network node 110, the controller/processor 240 of the network node 210, the UE 120, the controller/processor 280 of the UE 220, the CU 310, the DU 330, the RU 340, or any other component(s) of FIG. 1, 2, or 3 may implement one or more techniques or perform one or more operations associated with reverse handover operations, as described in more detail elsewhere herein. For example, the controller/processor 240 of the network node 210, the controller/processor 280 of the UE 220, any other component(s) of FIG. 2, the CU 310, the DU 330, or the RU 340 may perform or direct operations of, for example, process 600 of FIG. 6, process 700 of FIG. 7, process 800 of FIG. 8, or other processes as described herein (alone or in conjunction with one or more other processors). The memory 242 may store data and program codes for the network node 110, the network node 210, the CU 310, the DU 330, or the RU 340. The memory 282 may store data and program codes for the UE 120 or the UE 220. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 210, the UE 220, the CU 310, the DU 330, or the RU 340, may cause the one or more processors to perform process 600 of FIG. 6, process 700 of FIG. 7, process 800 of FIG. 8, or other processes as described herein. In some examples, executing instructions may include running the instructions, converting the instructions, compiling the instructions, and/or interpreting the instructions, among other examples. In some aspects, a first entity (e.g., a UE and/or a network node) may provide a communication to a second entity (e.g., another UE and/or network node) by providing the communication directly to the second entity or indirectly to the second entity (e.g., via one or more additional entities). The term “providing” refers to either directly providing or indirectly providing. Similarly, the term “obtaining” refers to either directly obtaining (e.g., directly obtaining a communication from another network node) or indirectly obtaining (e.g., obtaining the communication from another network node via one or more additional network nodes).

In some aspects, a UE (e.g., the UE 220) includes means for obtaining, from a first network node via a source cell, a reverse handover command associated with a second handover operation for handing over the UE from a first target cell to a second target cell; means for performing a first handover operation to hand over the UE from the source cell to the first target cell; and/or means for performing the second handover operation to hand over the UE from the first target cell to the second target cell. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first network node (e.g., the network node 210) includes means for providing, to a second network node, a first handover request message associated with a first handover operation for handing over a UE from a source cell to a first target cell, the first handover request message including a reverse handover indication associated with a second handover operation for handing over the UE from the first target cell to a second target cell; and/or means for obtaining, from the UE, an access communication associated with the second handover operation. The means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a second network node (e.g., the network node 210) includes means for obtaining, from a first network node, a first handover request message associated with a first handover operation for handing over a UE from a source cell to a first target cell, the first handover request message including a reverse handover indication associated with a second handover operation for handing over the UE from the first target cell to a second target cell; and/or means for obtaining, from the UE, an access communication associated with the first handover operation. The means for the second network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

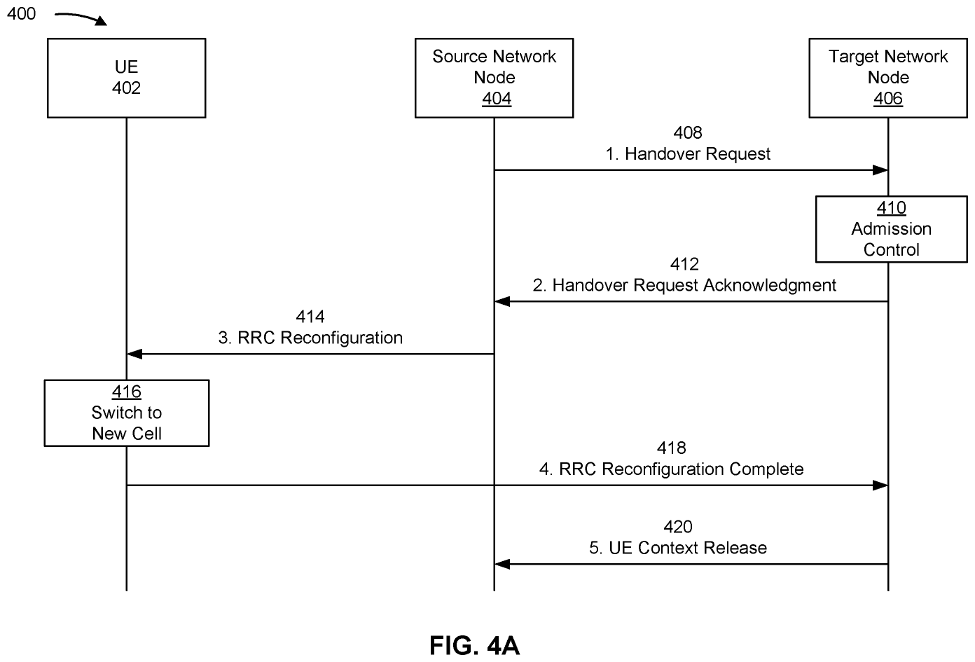

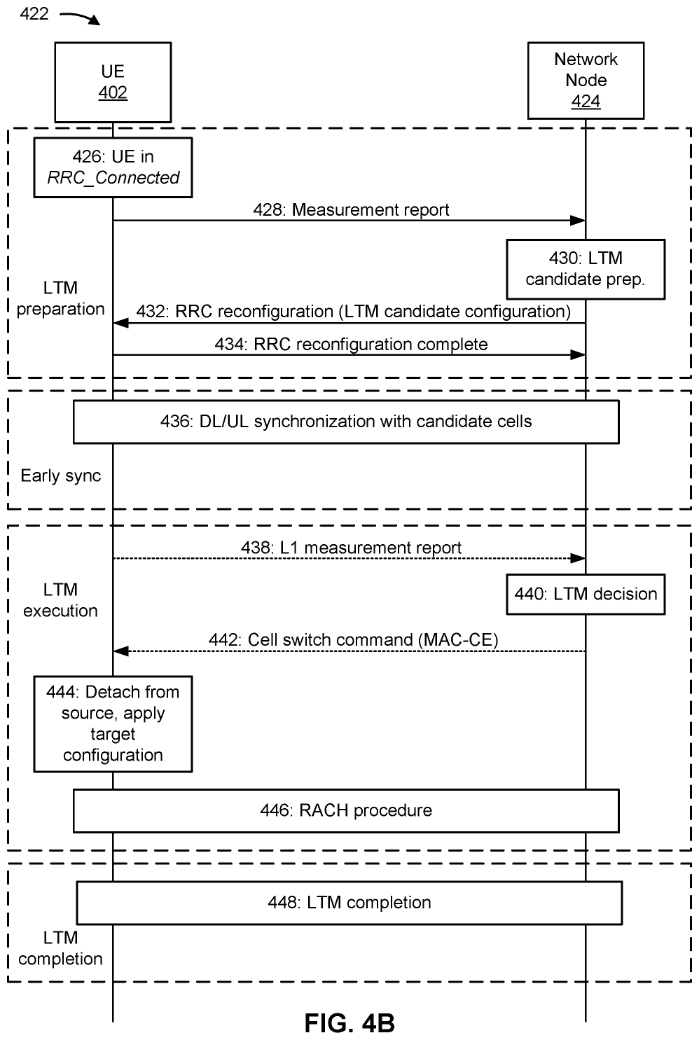

FIG. 4A is a diagram illustrating an example of a handover procedure 400, in accordance with the present disclosure. The handover procedure may be performed by a UE 402, a source network node 404 (for example, a network node 110), and a target network node 406 (for example, another network node 110). As used herein, “source network node” may refer to a serving network node or a network node with which the UE 402 currently has an active or established connection. “Target network node” may refer to a network node that is identified as a network node to replace a serving network node for a UE 402 (for example, as part on a handover procedure). In some examples, the source network node 404 may be associated with a primary cell (PCell) and the target network node 406 may be associated with a target cell to replace the source network node 404 as the PCell. In some other examples, the source network node 404 may be associated with a primary secondary cell (PSCell) and the target network node 406 may be a target cell to replace the source network node 404 as the PSCell.

As shown in FIG. 4A, in a first operation 408, the source network node 404 may initiate handover of the UE 402 to the target network node 406 by transmitting a handover request message to the target network node 406. The source network node 404 may transmit the handover request message to the target network node 406 over an Xn, X2, or a next generation application protocol (NGAP) interface, among other examples. In a second operation 410, the target network node 406 may perform admission control procedures associated with the handover based at least in part on receiving the handover request message. In a third operation 412, the target network node 406 may transmit a handover request acknowledgment message to the source network node 404 (for example, if the admission control procedures indicate that the target network node 406 can accept the handover of the UE 402). The handover request acknowledgment message may include an RRC configuration for connection to the target network node 406.

In a fourth operation 414, the source network node 404 may transmit the RRC configuration to the UE 402 by forwarding the RRC configuration of the handover request acknowledgment message to the UE 402. In a fifth operation 416, the UE 402 may change an RRC connection from the source network node 404 to the target network node 406 based at least in part on the RRC configuration. In a sixth operation 418, the UE 402 may transmit an RRC reconfiguration complete message to the target network node 406. The RRC reconfiguration complete message may indicate that the UE 402 has changed the RRC connection from the source network node 404 to the target network node 406. In a seventh operation 420, the target network node 406 may transmit a UE context release message to the source network node 404. The UE context release message may indicate that the handover of the UE 402 to the target network node 406 was successful.

FIG. 4B is a diagram illustrating an example 422 of an LTM procedure, in accordance with the present disclosure.

In some examples, a network node 424 may instruct a UE 402 to change serving cells, such as when the UE 402 moves away from coverage of a current serving cell (sometimes referred to as a source cell) and towards coverage of a neighboring cell (sometimes referred to as a target cell). In some cases, the network node 424 may instruct the UE 402 to change cells using a layer 3 (L3) handover procedure. An L3 handover procedure may include the network node 424 transmitting, to the UE 402, an RRC reconfiguration message indicating that the UE 402 should perform a handover procedure to a target cell, which may be transmitted in response to the UE 402 providing the network node 424 with an L3 measurement report indicating signal strength measurements associated with various cells (e.g., measurements associated with the source cell and one or more neighboring cells). In response to receiving the RRC reconfiguration message, the UE 402 may communicate with the source cell and the target cell to detach from the source cell and connect to the target cell (e.g., the UE 402 may establish an RRC connection with the target cell). Once handover is complete, the target cell may communicate with a user plane function (UPF) of a core network to instruct the UPF to switch a user plane path of the UE 402 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 402 may be configured to perform a lower-layer (e.g., L1 and/or L2) handover operation, sometimes referred to an LTM operation or an LTM procedure, such as the example 424 LTM operation shown in FIG. 4B. As shown in FIG. 4B, the LTM operation may include four phases: an LTM preparation phase, an early synchronization phase (shown as “early sync” in FIG. 4B), an LTM execution phase, and/or an LTM completion phase.

During the LTM preparation phase, and as indicated by reference number 426, the UE 402 may be in an RRC connected state (sometimes referred to as RRC_Connected) with a source cell. As indicated by reference number 428, the UE 402 may transmit, and the network node 424 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. In some examples, based at least in part on the measurement report or other information, the network node 424 may decide to use LTM, and thus, as indicated by reference number 430, the network node 424 may initiate LTM candidate preparation.

As shown by reference number 432, the network node 424 may transmit, and the UE 402 may receive, an RRC reconfiguration message (sometimes referred to as an RR (′Reconfiguration message), which may include an LTM candidate configuration. More particularly, the RRC reconfiguration message may indicate a configuration of one or more LTM candidate target cells, which may be candidate cells to become a serving cell of the UE 402 and/or cells for which the UE 402 may later be triggered to perform an LTM procedure. The UE 402 may store the configuration of the one or more LTM candidate cell configurations and, in response, as shown by reference number 434, may transmit, to the network node 424, an RRC reconfiguration complete message (sometimes referred to as an RR (ReconfigurationComplete message).

During the early synchronization phase, and as indicated by reference number 436, the UE 402 may optionally perform downlink/uplink synchronization with the candidate cells associated with the one or more LTM candidate cell configurations. For example, the UE 402 may perform downlink synchronization and timing advance acquisition with the one or more candidate target cells prior to receiving an LTM switch command. In some aspects, performing the early synchronization with the one or more candidate cells may reduce latency associated with performing a random access channel (RACH) procedure later in the LTM procedure, which is described in more detail below in connection with reference number 446.

During the LTM execution phase, and as indicated by reference number 438, the UE 402 may perform L1 measurements on the configured LTM candidate target cells, and thus may transmit, to the network node 424, lower-layer (e.g., L1) measurement reports. As indicated by reference number 440, based at least in part on the lower-layer measurement reports, the network node 424 may decide to execute an LTM cell switch to a target cell. Accordingly, as shown by reference number 442, the network node 424 may transmit, and the UE 402 may receive, a MAC control element (MAC-CE) or similar message triggering an LTM cell switch (the MAC-CE or similar message is sometimes referred to herein as a cell switch command). The cell switch command may include an indication of a candidate configuration index associated with the target cell. As shown by reference number 444, based at least in part on receiving the cell switch command, the UE 402 may switch to the configuration of the LTM candidate target cell (e.g., the UE 402 may detach from the source cell and apply the target cell configuration). Moreover, as shown by reference number 446, the UE 402 may perform a RACH procedure towards the target cell, such as when a timing advance associated with the target cell is not available (e.g., in examples in which the UE 120 did not perform the early synchronization as described above in connection with reference number 436).

During the LTM completion phase, and as indicated by reference number 448, the UE 402 may indicate successful completion of the LTM cell switch towards the target cell. In this way, cell switch to a target cell may be performed using less overhead than for an L3 handover procedure and/or a cell switch to a target cell may be associated with reduced latency as compared to L3 handover procedure.

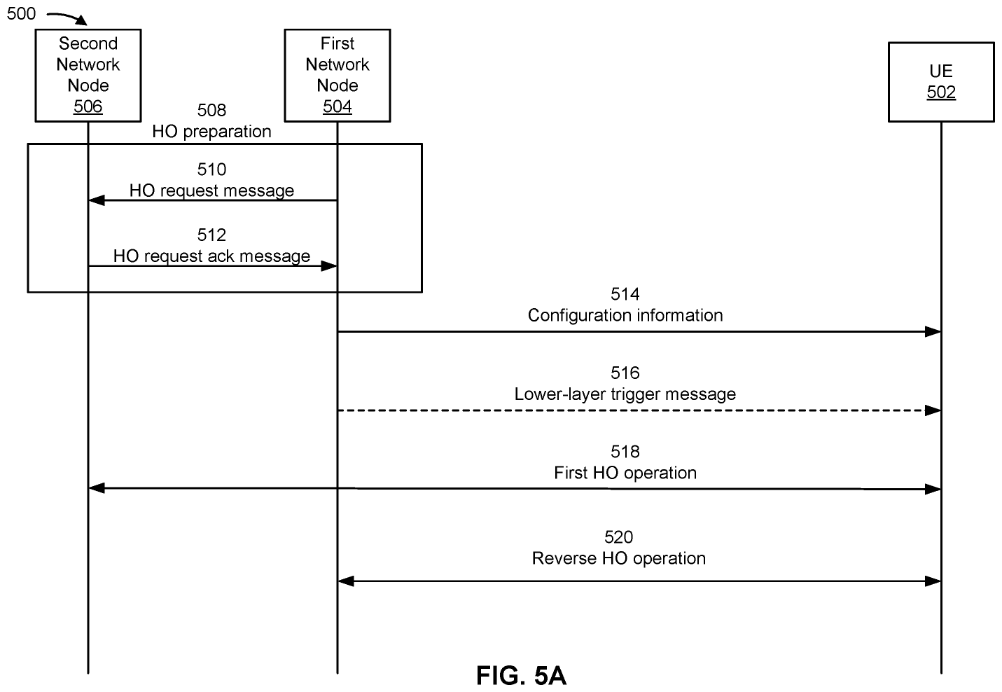

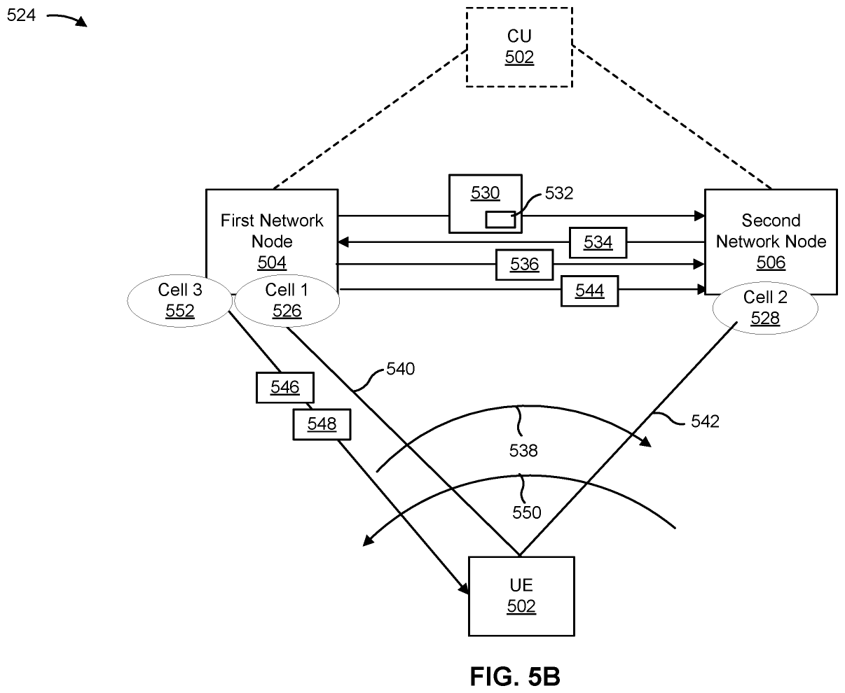

FIG. 5A is a diagram illustrating an example 500 associated with reverse handover operations, in accordance with the present information. As shown, a UE 502 may communication with a first network node 504 and a second network node 506. In some aspects, the UE 502 may be, be similar to, include, of be included in, the UE 402 depicted in FIG. 4 and/or the UE 120 depicted in FIG. 1-3. The first network node 504 and/or the second network node 506 may be, be similar to, include, of be included in the network node 424 depicted in FIGS. 4B, the network node 404 and/or the network node 406 depicted in FIG. 4A, one or more components of the disaggregated base station architecture 300 depicted in FIG. 3, the network node 210 depicted in FIG. 2, and/or the network node 110 depicted in FIG. 1. In some aspects, the first network node 504 and the second network node 506 may be distinct devices in a same location or different locations. In some other aspects, the first network node 504 and the second network node 506 may be different functions and/or components of a same network device (e.g., gNB).

As shown by reference number 508, the first network node 504 and the second network node 508 may perform a handover preparation (“HO preparation”). For example, as shown by reference number 510, the first network node 504 may provide a handover request message to the second network node 506. The handover request message may be associated with a first handover operation to hand the UE 502 over from a source cell to a first target cell. The first target cell may be associated with the second network node 506. The handover request message may include a reverse handover indication associated with a second handover operation for handing over the UE 502 from the first target cell to a second target cell. The second target cell may be the source cell and/or another serving cell (e.g., associated with the first network node 504).

As shown by reference number 512, the second network node 506 may provide, to the first network node 504, a handover request acknowledgment message. The handover request acknowledgment message may include an acknowledgement and acceptance of the second handover operation. In some aspects, the handover request acknowledgement message may include other preparation information such as, for example, a suggested admitted service time associated with connection, by the UE 502, to the first target cell. As shown by reference number 514, the first network node 504 may provide, and the UE 502 may obtain, configuration information. In some aspects, the configuration information may include, for example, a first configuration associated with the first target cell and a second configuration associated with the second target cell. The first configuration may include a first RRC configuration and the second configuration may include a second RRC configuration.

As shown by reference number 516, the first network node 504 may provide, and the UE 502 may obtain, a lower-layer trigger message. The lower-layer trigger message may include a layer 1 and/or layer 2 trigger message and may be associated with the first handover operation and the second handover operation. In some aspects, the lower-layer trigger message may include an LTM medium access control (MAC) control element (MAC CE). In some aspects, the lower-layer trigger message may include an indication of a minimum admitted service time associated with connection, by the UE 502, to the first target cell prior to performance of the second handover operation. In some aspects, the configuration information may include an indication of the minimum admitted service time.

In some aspects, the lower-layer trigger message may indicate an associated logical channel identifier (ID) associated with at least one of a first configuration or a second LTM configuration. In some aspects, the lower-layer trigger message may indicate at least one of the first LTM configuration or the second LTM configuration. In some aspects, the configuration information may include a conditional handover (CHO) configuration for performing a CHO as the second handover operation.

As shown by reference number 518, the UE 502 and the second network node 506 may perform the first handover operation, to hand the UE 502 over from a source cell to a first target cell. In some aspects, the UE 502 may perform the first handover operation based on performing a first lower-layer triggered mobility (LTM) handover operation and based on obtaining the lower-layer trigger message.

As shown by reference number 520, the UE 502 and the first network node 504 may perform a reverse handover operation. For example, the reverse handover operation may be referred to as a second handover operation and may be performed to hand the UE 502 over from the first target cell to a second target cell. In some aspects, the UE 502 may perform the second handover operation based on performing a second LTM handover operation and based on obtaining the lower-layer trigger message. In some aspects, the second handover operation may include a CHO and the UE 502 may maintain the CHO configuration after performing the first handover operation. For example, the UE 502 may maintain the CHO configuration based on obtaining the CHO configuration while connected to the source cell.

FIG. 5B is a diagram illustrating another example 524 associated with reverse handover operations, in accordance with the present disclosure. In some aspects, enhancements to handover coordination between the first network node 504 and the second network node 506, associated with a first handover to hand the UE 504 over from a first cell (“cell 1”) 526 (e.g., a source cell) to a first target cell (“cell 2”) 528, may be used to prepare for a reverse handover, as described herein. For example, the first network node 504 may provide a first handover request message 530 that includes a reverse handover indication 532 associated with a second handover operation for handing over the UE 502 from the first target cell 528 to a second target cell (e.g., cell 1 526 or cell 3 552).

After the UE 502 connects to cell 2 528, the second network node 506 may trigger a UE handover back to the first network node 504 based on the indication 532. In some aspects, the reverse handover indication 532 may include a duration indication indicative of a duration associated with an admitted service time associated with connection, by the UE 502, to the first target cell (cell 2 528) prior to performance of the second handover operation. In some aspects, the reverse handover indication may include a timing indication indicative of a time range within which the second handover operation is to be performed. For example, in some aspects, the duration may correspond to a network energy saving (NES) mode associated with the source cell (cell 1 526). For example, in some aspects, the first network node 504 may activate an NES mode based on the duration (e.g., while the UE 502 is connected to cell 2 528). For example, the first network node 504 may defer transition of cell 1 526 to NES mode based on whether the second network node 506 admits the UE 502. If the UE 502 is admitted for a duration, the first network node 504 may plan the NES mode for cell 1 526 based at least in part on the admitted duration.

In some aspects, the second network node 506 may provide a handover request acknowledgment message 534 to accept the first handover operation. In some aspects, the second network node 506 may accept the first handover operation based on the handover request message 530 including the reverse handover indication. In some aspects, the handover request message 530 may include a suggested admitted service time associated with connection, by the UE 502, to the first target cell 528. In some aspects, the first network node 504 may provide a modification request message 536 to the second network node 506. The modification request message may indicate at least one of a modification of an admitted service time associated with connection, by the UE 502, to the first target cell 528, or a cancellation of the second handover operation.

In implementations in which the second network node 506 has a CU/DU split, the CU may forward the reverse handover indication received in Xn handover preparation onto F1 to the DU. The DU may admit the UE 502 based on the indication and respond to the CU, which may acknowledge the first handover request message 530 via an Xn protocol message.

As shown by reference number 538, the first handover operation (sometimes referred to as a “forward handover” operation or a “temporary handover” operation) may be executed, moving the UE 502 from connection 540 with cell 1 526 to connection 542 with cell 2 528. The first network node 504 may provide a second request message 544 to the second network node 506 to request the reverse handover. To facilitate the second handover operation, the second request message may indicate the UE ID. In some aspects, the UE ID may include an Xn application protocol (XnAP) UE ID. For example, in some aspects, the first request message 530 may include the UE ID and at least one of the first handover request message or a context release message may include an indication to maintain the UE ID. In some aspects, the second request message 544 may indicate a cell ID corresponding to the second target cell 526.

In some aspects, first network node 504 may provide, to the UE 502, a reverse handover command 546 associated with the second handover operation. In some aspects, the first network node 504 may provide, to the UE 502, configuration information 548 including a first configuration associated with the first target cell and a second configuration associated with the second target cell. In some aspects, the second network node 506 may reject the second request 546 from the first network node 504 based on a measurement report received from the UE 502 while the UE 502 is served on the cell 2 528. For example, the measurement report may include a cause value that indicates low measurements associated with the second target cell (e.g., cell 1 526), or that the UE 502 no longer available. The UE 502 may perform the second handover operation 550.

In some cases, intra-CU mobility may be supported. For example, the UE 502 may be configured for LTM operations, in which the first network node 504 is a first DU and the second network node 506 is a second DU. The UE 502 may be configured with subsequent LTM. In this case, the first network node 504 may provide an LTM MAC CE (or L1 trigger) that triggers the UE 502 to switch to cell 2 528 and back to cell 1 526 (or other DUI cell/cell group (CG)). The LTM MAC CE may indicate multiple target cells (or CGs), where the UE 502 hops between the target cells/CGs in sequence. The cell switch command may indicate a minimum time interval before the reverse cell switch. Alternatively, the time interval for the reverse cell switch may be configured via RRC. The LTM MAC CE may be identified by a logic channel ID (LCID), or the LTM MAC CE may include an indicator of multiple LTM configurations, e.g., that of cell 2 528 for the forward cell switch and the configuration of cell 1 526 for the reverse cell switch.

In some aspects, the UE 504 may be configured with CHO to a source cell (or other serving cell) while on the source cell 526. The UE 502 may receive a CHO configuration for handover to cell 1 526 or other serving cell via RRC from the first network node 504. The forward handover may be prepared between the network nodes 504 and 506 and the handover command for the forward handover may be delivered to the UE 502. The UE 502 may execute the forward handover but may not release the CHO configuration to the second target cell. The UE 502 may retain the CHO configuration to the second target cell based on an implicit determination that the UE 502 was configured with the CHO configuration to the source cell while served on the source cell, or the UE 502 may retain the CHO configuration to the second target cell based on a flag in RRC from the first network node 504. The UE 502 may receive a condition configuration associated with triggering the execution of the reverse CHO. The condition configuration may include channel conditions associated with the new source link and/or target link. The condition configuration may include a timer value, and upon timer expiry the UE 502 may be triggered to execute the reverse CHO. The time value may indicate absolute time or a countdown with respect to a reference that could be the time of CHO configuration for the reverse handover or the time of handover completion of the forward handover. The time value may be associated with the NES mode of operation of the source cell of the forward handover. The first network node 504 may provide the UE 502 with the CHO configuration for reverse handover along with the handover command (received from the second network node 506) in the same message. A flag may be included to differentiate which RRC configuration is for the forward handover and which is for the reverse handover.

In some aspects, the second network node 506 may include a CHO configuration for reverse handover in a handover command of the forward handover. For example, the first network node 504 may provide the second network node 506 with a CHO configuration associated with the reverse handover. The second network node 506 may admit the UE 502 and generate the corresponding handover command. Since the handover command is an RRC configuration, the second network node 506 may encapsulate the CHO configuration received from the first network node 504 into the handover command. The conditions for triggering the reverse CHO configuration may be also provided by the first network node 504. The conditions for triggering the reverse CHO configuration may be handled external to the CHO configuration, allowing the second network node 506 to alter those conditions as necessary. In some aspects, the second network node 506 may generate the trigger conditions for the CHO configuration, which may be based on coordination with the first network node 504 (e.g., the first network node 504 may provide time requested for handing over the UE 502 to the second network node 506 as associated with an NES mode on the source cell, and the second network node 506 may generate the trigger conditions accordingly).

In some aspects, the first handover operation may be a regular handover operation or a conditional handover operation. In some aspects, the source cell, the first target cell, and/or the second target cell may be configured with a timed and/or semi-persistent cell discontinuous transmission and/or discontinuous reception (DTX/DRX) configuration. In some aspects, the first (e.g., forward) handover operation may be linked to a semi-persistent cell DTX/DRX of the source cell. In some aspects, the source cell (e.g., the first network node 504) may share information about its cell DTX/DRX configuration with the first target cell. The first target cell may use the information to facilitate handing over the UE 502 back to the second target cell (e.g., the source cell) in association with a cell DTX/DRX cycle (e.g., an activity profile) associated with the cell DTX/DRX configuration. In some aspects, instead of the first network node 504 providing temporary handover timer information to the UE 502, the UE 502 may use the semi-persistent cell DTX/DRX configuration to determine a temporary handover duration based thereon. In some aspects, the UE 502 may be handed over back to the second target cell (e.g., the source cell)) after the temporary handover operation based on the first target cell activating a reception on-duration associated with a cell DTX/DRX cycle associated with a cell DTX/DRX configuration associated with the first target cell.

FIG. 6 is a diagram illustrating an example process 600 performed, for example, by a UE, in accordance with the present disclosure. Example process 600 is an example where the UE (e.g., UE 502) performs operations associated with reverse handover operations.

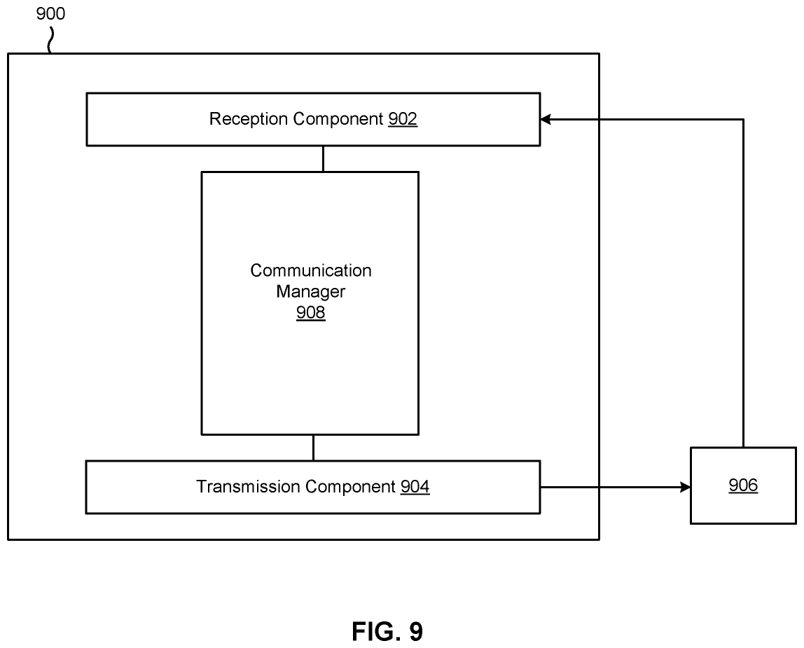

As shown in FIG. 6, in some aspects, process 600 may include obtaining, from a first network node via a source cell, a reverse handover command associated with a second handover operation for handing over the UE from a first target cell to a second target cell (block 610). For example, the UE (e.g., using communication manager 908 and/or reception component 902, depicted in FIG. 9) may obtain, from a first network node via a source cell, a reverse handover command associated with a second handover operation for handing over the UE from a first target cell to a second target cell, as described above.

As further shown in FIG. 6, in some aspects, process 600 may include performing a first handover operation to hand over the UE from the source cell to the first target cell (block 620). For example, the UE (e.g., using communication manager 908, reception component 902, and/or transmission component 904, depicted in FIG. 9) may perform a first handover operation to hand over the UE from the source cell to the first target cell, as described above.

As further shown in FIG. 6, in some aspects, process 600 may include performing the second handover operation to hand over the UE from the first target cell to the second target cell (block 630). For example, the UE (e.g., using communication manager 908, reception component 902, and/or transmission component 904, depicted in FIG. 9) may perform the second handover operation to hand over the UE from the first target cell to the second target cell, as described above.

Process 600 may include additional aspects, such as any single aspect or any combination of aspects described below and/or in connection with one or more other processes described elsewhere herein.

In a first aspect, the second target cell comprises the source cell. In a second aspect, alone or in combination with the first aspect, process 600 includes obtaining, from the first network node, configuration information comprising a first configuration associated with the first target cell and a second configuration associated with the second target cell. In a third aspect, alone or in combination with one or more of the first and second aspects, the first configuration comprises a first RRC configuration and the second configuration comprises a second RRC configuration.

In a fourth aspect, alone or in combination with one or more of the first through third aspects, process 600 includes obtaining a lower-layer trigger message associated with the first handover operation and the second handover operation, wherein performing the first handover operation comprises performing a first LTM handover operation based on obtaining the lower-layer trigger message. In a fifth aspect, alone or in combination with one or more of the first through fourth aspects, performing the second handover operation comprises performing a second LTM handover operation based on obtaining the lower-layer trigger message. In a sixth aspect, alone or in combination with one or more of the first through fifth aspects, the lower-layer trigger message comprises an LTM MAC CE.

In a seventh aspect, alone or in combination with one or more of the first through sixth aspects, the lower-layer trigger message comprises an indication of a minimum admitted service time associated with connection, by the UE, to the first target cell prior to performance of the second handover operation. In an eighth aspect, alone or in combination with one or more of the first through seventh aspects, the configuration information comprises an indication of a minimum admitted service time associated with connection, by the UE, to the first target cell prior to performance of the second LTM handover operation. In a ninth aspect, alone or in combination with one or more of the first through eighth aspects, the lower-layer trigger message indicates an associated logical channel ID associated with at least one of the first LTM configuration or the second LTM configuration. In a tenth aspect, alone or in combination with one or more of the first through ninth aspects, the lower-layer trigger message indicates at least one of the first LTM configuration or the second LTM configuration.

In an eleventh aspect, alone or in combination with one or more of the first through tenth aspects, the configuration information comprises a CHO configuration, and performing the second handover operation comprises performing a CHO operation associated with the conditional CHO configuration. In a twelfth aspect, alone or in combination with one or more of the first through eleventh aspects, process 600 includes maintaining the CHO configuration after performing the first handover operation. In a thirteenth aspect, alone or in combination with one or more of the first through twelfth aspects, maintaining the CHO configuration comprises maintaining the CHO configuration based on obtaining the CHO configuration while connected to the source cell.

In a fourteenth aspect, alone or in combination with one or more of the first through thirteenth aspects, the configuration information includes a flag associated with maintaining the CHO configuration, wherein maintaining the CHO configuration comprises maintaining the CHO configuration based on the configuration information including the flag. In a fifteenth aspect, alone or in combination with one or more of the first through fourteenth aspects, the configuration information further comprises a CHO condition configuration that indicates a trigger condition for triggering the CHO operation.

In a sixteenth aspect, alone or in combination with one or more of the first through fifteenth aspects, the trigger condition comprises at least one of a channel condition associated with a communication channel between the UE and the first target cell or a communication channel between the UE and the second target cell. In a seventeenth aspect, alone or in combination with one or more of the first through sixteenth aspects, the trigger condition comprises a timer value associated with a triggering timer, wherein performing the CHO operation comprises performing the CHO operation based on an expiry of the triggering timer. In an eighteenth aspect, alone or in combination with one or more of the first through seventeenth aspects, the timer value comprises an absolute time.

In a nineteenth aspect, alone or in combination with one or more of the first through eighteenth aspects, the timer value comprises a countdown value associated with a reference time. In a twentieth aspect, alone or in combination with one or more of the first through nineteenth aspects, the reference time comprises a time associated with obtaining the configuration information. In a twenty-first aspect, alone or in combination with one or more of the first through twentieth aspects, the reference time comprises a time of completion of the first handover operation. In a twenty-second aspect, alone or in combination with one or more of the first through twenty-first aspects, the timer value corresponds to a duration of a network energy savings mode associated with the source cell.

In a twenty-third aspect, alone or in combination with one or more of the first through twenty-second aspects, obtaining the configuration information comprises obtaining a configuration message that includes the CHO configuration and a handover command associated with the first handover operation. In a twenty-fourth aspect, alone or in combination with one or more of the first through twenty-third aspects, the configuration information comprises a flag that indicates at least one of an association between the first configuration and the first handover operation or an association between the second configuration and the second handover operation.

In a twenty-fifth aspect, alone or in combination with one or more of the first through twenty-fourth aspects, the first configuration comprises a handover command associated with the first handover operation and the second configuration comprises a CHO configuration, wherein the handover command comprises the CHO configuration and performing the second handover operation comprises performing a CHO operation associated with the CHO configuration. In a twenty-sixth aspect, alone or in combination with one or more of the first through twenty-fifth aspects, the handover command comprises an RRC configuration, wherein the CHO configuration is encapsulated within the RRC configuration. In a twenty-seventh aspect, alone or in combination with one or more of the first through twenty-sixth aspects, process 600 includes obtaining, from the first network node, a CHO condition configuration that indicates a trigger condition for triggering the CHO operation.

In a twenty-eighth aspect, alone or in combination with one or more of the first through twenty-seventh aspects, process 600 includes obtaining, from the first network node, at least one reference signal associated with the second target cell, and providing, to a second network node, a measurement report including one or more measurements associated with the at least one reference signal, wherein performing the second handover operation comprises performing the second handover operation based on the one or more measurements.

In a twenty-ninth aspect, alone or in combination with one or more of the first through twenty-eighth aspects, the source cell is associated with a cell DTX/DRX configuration. In a thirtieth aspect, alone or in combination with the twenty-ninth aspect, performing the first handover operation comprises performing the first handover operation in association with the cell DTX/DRX operation. In a thirty-first aspect, alone or in combination with the twenty-ninth aspect, performing the second handover operation comprises performing the second handover operation based on a cell DTX/DRX cycle associated with the cell DTX/DRX configuration. In a thirty-second aspect, alone or in combination with the twenty-ninth aspect, process 600 includes obtaining information associated with the cell DTX/DRX configuration, and performing the second handover operation comprises performing the second handover operation based on the information associated with the cell DTX/DRX configuration. In a thirty-third aspect, alone or in combination with the twenty-ninth aspect, performing the second handover operation comprises performing the second handover operation based on activation, associated with the first target cell, of a reception active duration of a DTX/DRX cycle associated with a DTX/DRX configuration associated with the first target cell.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a first network node, in accordance with the present disclosure. Example process 700 is an example where the first network node (e.g., first network node 504) performs operations associated with reverse handover operations.

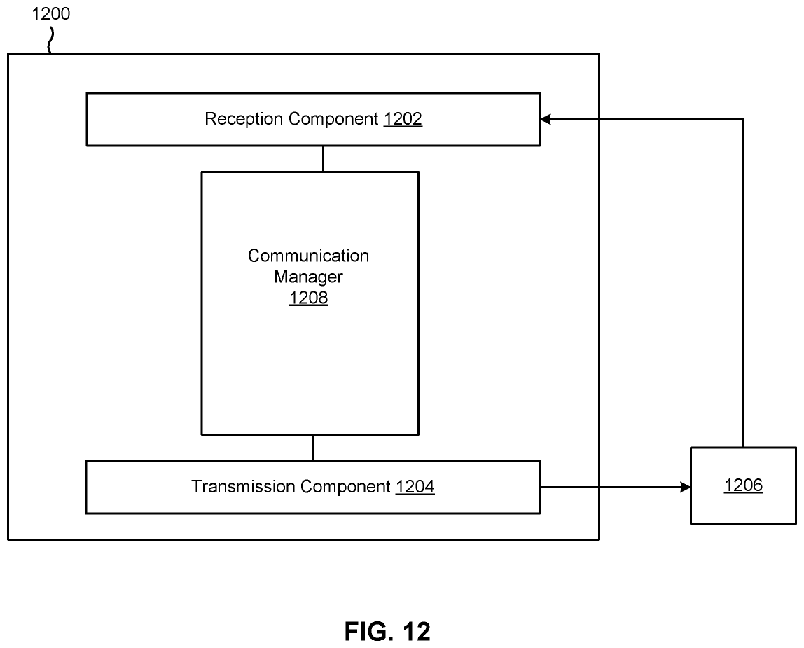

As shown in FIG. 7, in some aspects, process 700 may include providing, to a second network node, a first handover request message associated with a first handover operation for handing over a UE from a source cell to a first target cell, the first handover request message including a reverse handover indication associated with a second handover operation for handing over the UE from the first target cell to a second target cell (block 710). For example, the first network node (e.g., using communication manager 1208 and/or transmission component 1204, depicted in FIG. 12) may provide, to a second network node, a first handover request message associated with a first handover operation for handing over a UE from a source cell to a first target cell, the first handover request message including a reverse handover indication associated with a second handover operation for handing over the UE from the first target cell to a second target cell, as described above.

As further shown in FIG. 7, in some aspects, process 700 may include obtaining, from the UE, an access communication associated with the second handover operation (block 720). For example, the first network node (e.g., using communication manager 1208 and/or reception component 1202, depicted in FIG. 12) may obtain, from the UE, an access communication associated with the second handover operation, as described above.

Process 700 may include additional aspects, such as any single aspect or any combination of aspects described below and/or in connection with one or more other processes described elsewhere herein.

In a first aspect, the second target cell comprises the source cell. In a second aspect, alone or in combination with the first aspect, the second target cell comprises a serving cell, other than the source cell, associated with the first network node. In a third aspect, alone or in combination with one or more of the first and second aspects, the reverse handover indication comprises a duration indication indicative of a duration associated with an admitted service time associated with connection, by the UE, to the first target cell prior to performance of the second handover operation. In a fourth aspect, alone or in combination with one or more of the first through third aspects, the reverse handover indication comprises a timing indication indicative of a time range within which the second handover operation is to be performed. In a fifth aspect, alone or in combination with one or more of the first through fourth aspects, the reverse handover indication comprises a cell ID associated with the second target cell.

In a sixth aspect, alone or in combination with one or more of the first through fifth aspects, process 700 includes obtaining, from the second network node, a handover request acknowledgment message comprising a suggested admitted service time associated with connection, by the UE, to the first target cell. In a seventh aspect, alone or in combination with one or more of the first through sixth aspects, process 700 includes activating an NES mode based on a duration associated with an admitted service time associated with connection, by the UE, to the first target cell.

In an eighth aspect, alone or in combination with one or more of the first through seventh aspects, process 700 includes providing a modification request message to the second network node, the modification request message indicating at least one of a modification of an admitted service time associated with connection, by the UE, to the first target cell, or a cancellation of the second handover operation. In a ninth aspect, alone or in combination with one or more of the first through eighth aspects, the reverse handover indication comprises an indication of a UE ID corresponding to the UE.

In a tenth aspect, alone or in combination with one or more of the first through ninth aspects, the UE ID comprises an Xn application protocol (XnAP) UE ID. In an eleventh aspect, alone or in combination with one or more of the first through tenth aspects, at least one of the first handover request message or a context release message comprises an indication to maintain the UE ID. In a twelfth aspect, alone or in combination with one or more of the first through eleventh aspects, process 700 includes providing, to the second network node, a second request message associated with the second handover operation, wherein the second request message indicates the UE ID. In a thirteenth aspect, alone or in combination with one or more of the first through twelfth aspects, the second request message indicates a cell ID corresponding to the second target cell.

In a fourteenth aspect, alone or in combination with one or more of the first through thirteenth aspects, process 700 includes providing, to the UE, a reverse handover command associated with the second handover operation. In a fifteenth aspect, alone or in combination with one or more of the first through fourteenth aspects, process 700 includes providing, to the UE, configuration information comprising a first configuration associated with the first target cell and a second configuration associated with the second target cell. In a sixteenth aspect, alone or in combination with one or more of the first through fifteenth aspects, the first configuration comprises a first RRC configuration and the second configuration comprises a second RRC configuration. In a seventeenth aspect, alone or in combination with one or more of the first through sixteenth aspects, the method further comprises providing a lower-layer trigger message associated with the first handover operation and the second handover operation.

In an eighteenth aspect, alone or in combination with one or more of the first through seventeenth aspects, the lower-layer trigger message comprises an LTM MAC CE. In a nineteenth aspect, alone or in combination with one or more of the first through eighteenth aspects, the lower-layer trigger message comprises an indication of a minimum admitted service time associated with connection, by the UE, to the first target cell prior to performance of the second handover operation. In a twentieth aspect, alone or in combination with one or more of the first through nineteenth aspects, the configuration information comprises an indication of a minimum admitted service time associated with connection, by the UE, to the first target cell prior to performance of the second handover operation. In a twenty-first aspect, alone or in combination with one or more of the first through twentieth aspects, the lower-layer trigger message indicates an associated LCID associated with at least one of the first configuration or the second configuration.

In a twenty-second aspect, alone or in combination with one or more of the first through twenty-first aspects, the lower-layer trigger message indicates at least one of the first configuration or the second configuration. In a twenty-third aspect, alone or in combination with one or more of the first through twenty-second aspects, the second configuration comprises a CHO configuration, and performing the second handover operation comprises performing a CHO operation associated with the conditional CHO configuration. In a twenty-fourth aspect, alone or in combination with one or more of the first through twenty-third aspects, the configuration information includes a flag associated with maintaining the CHO configuration. In a twenty-fifth aspect, alone or in combination with one or more of the first through twenty-fourth aspects, the configuration information further comprises a CHO condition configuration that indicates a trigger condition for triggering the CHO operation.

In a twenty-sixth aspect, alone or in combination with one or more of the first through twenty-fifth aspects, the trigger condition comprises at least one of a channel condition associated with a communication channel between the UE and the first target cell or a channel condition associated with a communication channel between the UE and the second target cell. In a twenty-seventh aspect, alone or in combination with one or more of the first through twenty-sixth aspects, the trigger condition comprises a timer value associated with a triggering timer for the CHO operation. In a twenty-eighth aspect, alone or in combination with one or more of the first through twenty-seventh aspects, the timer value comprises an absolute time. In a twenty-ninth aspect, alone or in combination with one or more of the first through twenty-eighth aspects, the timer value comprises a countdown value associated with a reference time. In a thirtieth aspect, alone or in combination with one or more of the first through twenty-ninth aspects, the reference time comprises a time associated with obtaining the configuration information. In a thirty-first aspect, alone or in combination with one or more of the first through thirtieth aspects, the reference time comprises a time of completion of the first handover operation.

In a thirty-second aspect, alone or in combination with one or more of the first through thirty-first aspects, the timer value corresponds to a duration of a network energy savings mode associated with the source cell. In a thirty-third aspect, alone or in combination with one or more of the first through thirty-second aspects, providing the configuration information comprises providing a configuration message that includes the CHO configuration and a handover command associated with the first handover operation. In a thirty-fourth aspect, alone or in combination with one or more of the first through thirty-third aspects, the configuration information comprises a flag that indicates at least one of an association between the first configuration and the first handover operation or an association between the second configuration and the second handover operation.

In a thirty-fifth aspect, alone or in combination with one or more of the first through thirty-fourth aspects, the first configuration comprises a handover command associated with the first handover operation, wherein the second configuration comprises a CHO configuration, and the handover command comprises the CHO configuration, and the second handover operation comprises a CHO operation associated with the CHO configuration. In a thirty-sixth aspect, alone or in combination with one or more of the first through thirty-fifth aspects, the handover command comprises an RRC configuration, wherein the CHO configuration is encapsulated within the RRC configuration. In a thirty-seventh aspect, alone or in combination with one or more of the first through thirty-sixth aspects, process 700 includes providing, from the first network node, a CHO condition configuration that indicates a trigger condition for triggering the CHO operation. In a thirty-eighth aspect, alone or in combination with one or more of the first through thirty-seventh aspects, the reverse handover indication comprises a CHO configuration associated with the second handover operation.

In a thirty-ninth aspect, alone or in combination with one or more of the first through thirty-eighth aspects, the source cell is associated with a cell DTX/DRX configuration. In a fortieth aspect, alone or in combination with the thirty-ninth aspect, the first handover operation is associated with the cell DTX/DRX operation. In a forty-first aspect, alone or in combination with the thirty-ninth aspect, process 700 includes performing the second handover operation based on a cell DTX/DRX cycle associated with the cell DTX/DRX configuration. In a forty-second aspect, alone or in combination with the thirty-ninth aspect, process 700 includes providing information associated with the cell DTX/DRX configuration; and performing the second handover operation based on the information associated with the cell DTX/DRX configuration. In a forty-third aspect, alone or in combination with the thirty-ninth aspect, process 700 includes performing the second handover operation based on activation, associated with the first target cell, of a reception active duration of a DTX/DRX cycle associated with a DTX/DRX configuration associated with the first target cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second network node, in accordance with the present disclosure. Example process 800 is an example where the second network node (e.g., second network node 506) performs operations associated with reverse handover operations.

As shown in FIG. 8, in some aspects, process 800 may include obtaining, from a first network node, a first handover request message associated with a first handover operation for handing over a UE from a source cell to a first target cell, the first handover request message including a reverse handover indication associated with a second handover operation for handing over the UE from the first target cell to a second target cell (block 810). For example, the second network node (e.g., using communication manager 1208 and/or reception component 1202, depicted in FIG. 12) may obtain, from a first network node, a first handover request message associated with a first handover operation for handing over a UE from a source cell to a first target cell, the first handover request message including a reverse handover indication associated with a second handover operation for handing over the UE from the first target cell to a second target cell, as described above.

As further shown in FIG. 8, in some aspects, process 800 may include obtaining, from the UE, an access communication associated with the first handover operation (block 820). For example, the second network node (e.g., using communication manager 1208 and/or reception component 1202, depicted in FIG. 12) may obtain, from the UE, an access communication associated with the first handover operation, as described above.

Process 800 may include additional aspects, such as any single aspect or any combination of aspects described below and/or in connection with one or more other processes described elsewhere herein.

In a first aspect, the second target cell comprises the source cell. In a second aspect, alone or in combination with the first aspect, the second target cell comprises a serving cell, other than the source cell, associated with the first network node. In a third aspect, alone or in combination with one or more of the first and second aspects, the reverse handover indication comprises a duration indication indicative of a duration associated with an admitted service time associated with connection, by the UE, to the first target cell prior to performance of the second handover operation. In a fourth aspect, alone or in combination with one or more of the first through third aspects, the reverse handover indication comprises a timing indication indicative of a time range within which the second handover operation is to be performed.

In a fifth aspect, alone or in combination with one or more of the first through fourth aspects, the reverse handover indication comprises a cell ID associated with the second target cell. In a sixth aspect, alone or in combination with one or more of the first through fifth aspects, process 800 includes providing, to the first network node, a handover request acknowledgment message comprising a suggested admitted service time associated with connection, by the UE, to the first target cell. In a seventh aspect, alone or in combination with one or more of the first through sixth aspects, process 800 includes obtaining, from the first network node, a modification request message indicating at least one of a modification of an admitted service time associated with connection, by the UE, to the first target cell, or a cancellation of the second handover operation.

In an eighth aspect, alone or in combination with one or more of the first through seventh aspects, process 800 includes providing, via a CU of the second network node to a DU of the second network node, the reverse handover indication, admitting, via the DU, the UE based on the reverse handover indication, and providing, via the CU to the first network node, a handover request acknowledgment message based on admitting the UE. In a ninth aspect, alone or in combination with one or more of the first through eighth aspects, the reverse handover indication comprises an indication of a UE ID corresponding to the UE. In a tenth aspect, alone or in combination with one or more of the first through ninth aspects, the UE ID comprises an Xn UE ID. In an eleventh aspect, alone or in combination with one or more of the first through tenth aspects, at least one of the first handover request message or a context release message comprises an indication to maintain the UE ID. In a twelfth aspect, alone or in combination with one or more of the first through eleventh aspects, process 800 includes obtaining, from the first network node, a second request message associated with the second handover operation, wherein the second request message indicates the UE ID. In a thirteenth aspect, alone or in combination with one or more of the first through twelfth aspects, the second request message indicates a cell ID corresponding to the second target cell.

In a fourteenth aspect, alone or in combination with one or more of the first through thirteenth aspects, process 800 includes providing, to the UE, a lower-layer trigger message associated with the second handover operation. In a fifteenth aspect, alone or in combination with one or more of the first through fourteenth aspects, the lower-layer trigger message comprises an LTM MAC CE.

In a sixteenth aspect, alone or in combination with one or more of the first through fifteenth aspects, the first handover request message comprises a second configuration associated with the second handover operation, the second configuration comprising a CHO configuration for a CHO operation, and process 800 includes admitting the first handover operation, generating a first handover command associated with the first handover operation, wherein the first handover command comprises an RRC configuration, and providing the first handover command to the first network node, wherein the first handover command includes the CHO configuration. In a seventeenth aspect, alone or in combination with one or more of the first through sixteenth aspects, process 800 includes encapsulating the CHO configuration within the RRC configuration. In an eighteenth aspect, alone or in combination with one or more of the first through seventeenth aspects, process 800 includes providing, to the first network node, an indication of an alteration of at least one trigger condition indicated by a CHO condition configuration.

In a nineteenth aspect, alone or in combination with one or more of the first through eighteenth aspects, process 800 includes generating a CHO condition configuration that indicates a trigger condition for triggering the CHO operation. In a twentieth aspect, alone or in combination with one or more of the first through nineteenth aspects, the CHO configuration includes the CHO condition configuration. In a twenty-first aspect, alone or in combination with one or more of the first through twentieth aspects, process 800 includes obtaining, from the first network node, a timing associated with the second handover operation, wherein generating the CHO condition configuration comprises generating the CHO condition configuration based on the timing. In a twenty-second aspect, alone or in combination with one or more of the first through twenty-first aspects, the reverse handover indication comprises a CHO configuration associated with the second handover operation.

In a twenty-third aspect, alone or in combination with one or more of the first through twenty-first aspects, the source cell is associated with a cell DTX/DRX configuration. In a twenty-fourth aspect, alone or in combination with the twenty-third aspect, the first handover operation is associated with the cell DTX/DRX operation. In a twenty-fifth aspect, alone or in combination with the twenty-third aspect, process 800 includes performing the second handover operation based on a cell DTX/DRX cycle associated with the cell DTX/DRX configuration. In a twenty-sixth aspect, alone or in combination with the twenty-third aspect, process 800 includes obtaining information associated with the cell DTX/DRX configuration; and performing the second handover operation based on the information associated with the cell DTX/DRX configuration. In a twenty-seventh aspect, alone or in combination with the twenty-third aspect, process 800 includes performing the second handover operation based on activation, associated with the first target cell, of a reception active duration of a DTX/DRX cycle associated with a DTX/DRX configuration associated with the first target cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 908.

In some aspects, the apparatus 900 may be configured to perform one or more operations described herein in connection with FIGS. 5A-5B. Additionally, or alternatively, the apparatus 900 may be configured to perform one or more processes described herein, such as process 600 of FIG. 6. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may obtain, from a first network node via a source cell, a reverse handover command associated with a second handover operation for handing over the UE from a first target cell to a second target cell. The communication manager 908, reception component 902, and/or transmission component 904 may perform a first handover operation to hand over the UE from the source cell to the first target cell. The communication manager 908, reception component 902, and/or transmission component 904 may perform the second handover operation to hand over the UE from the first target cell to the second target cell.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for obtaining, providing, transmitting, receiving, determining, and/or performing may include various processing system components, such as a receive processor, a transmit processor, a controller/processor, a memory, or a combination thereof, of the UE described above in connection with FIG. 2.

In some aspects, the communication manager 908 may include one or more antennas, a modem, a controller/processor, a memory, or a combination thereof, of the UE described in connection with FIG. 2. In some aspects, the communication manager 908 may include the reception component 902 and/or the transmission component 904. In some aspects, the communication manager 908 may be, be similar to, include, or be included in, the communication manager 140 depicted in FIGS. 1 and 2.

The communication manager 908 and/or the reception component 902 may obtain, from the first network node, configuration information comprising a first configuration associated with the first target cell and a second configuration associated with the second target cell. The communication manager 908 and/or the reception component 902 may obtain a lower-layer trigger message associated with the first handover operation and the second handover operation, wherein performing the first handover operation comprises performing a first lower-layer triggered mobility (LTM) handover operation based on obtaining the lower-layer trigger message.

The communication manager 908 may maintain the CHO configuration after performing the first handover operation. The communication manager 908 and/or the reception component 902 may obtain, from the first network node, a CHO condition configuration that indicates a trigger condition for triggering the CHO operation. The communication manager 908 and/or the reception component 902 may obtain, from the first network node, at least one reference signal associated with the second target cell. The communication manager 908 and/or the transmission component 904 may provide, to a second network node, a measurement report including one or more measurements associated with the at least one reference signal.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

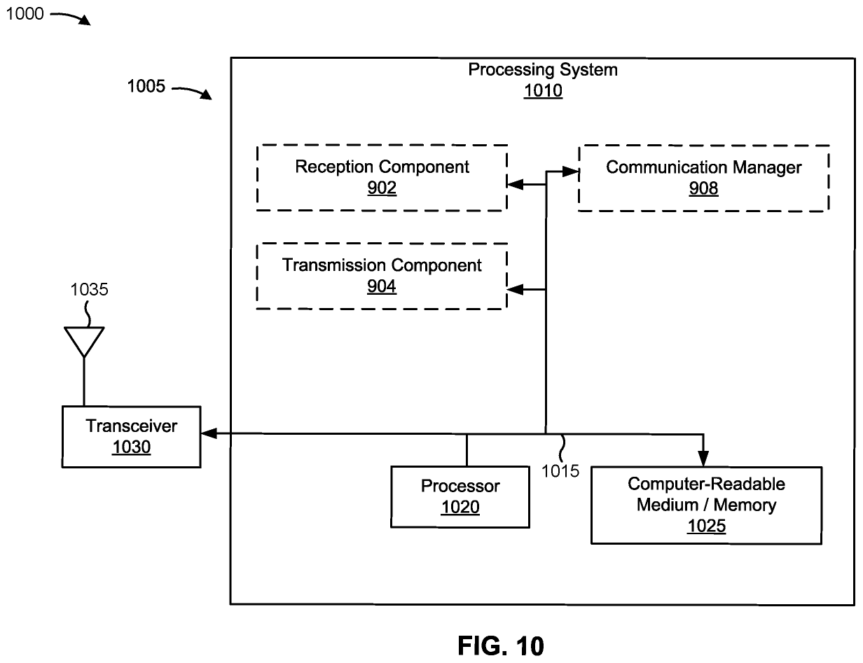

FIG. 10 is a diagram illustrating an example 1000 of a hardware implementation for an apparatus 1005 employing a processing system 1010, in accordance with the present disclosure. The apparatus 1005 may be a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor 1020, the illustrated components, and the computer-readable medium/memory 1025. The bus 1015 may also link various other circuits, such as timing sources, peripherals, voltage regulators, and/or power management circuits.

The processing system 1010 may be coupled to a transceiver 1030. The transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes a processor 1020 coupled to a computer-readable medium/memory 1025. The processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the base station 110 and may include the memory 242 and/or at least one of the TX MIMO processor 230, the RX processor 238, and/or the controller/processor 240. In some aspects, the apparatus 1005 for wireless communication includes means for obtaining, from a first network node via a source cell, a reverse handover command associated with a second handover operation for handing over the UE from a first target cell to a second target cell, performing a first handover operation to hand over the UE from the source cell to the first target cell, and performing the second handover operation to hand over the UE from the first target cell to the second target cell. The aforementioned means may be one or more of the aforementioned components of the apparatus 1005 and/or the processing system 1010 of the apparatus 1005 configured to perform the functions recited by the aforementioned means. As described elsewhere herein, the processing system 1010 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 10 is provided as an example. Other examples may differ from what is described in connection with FIG. 10.

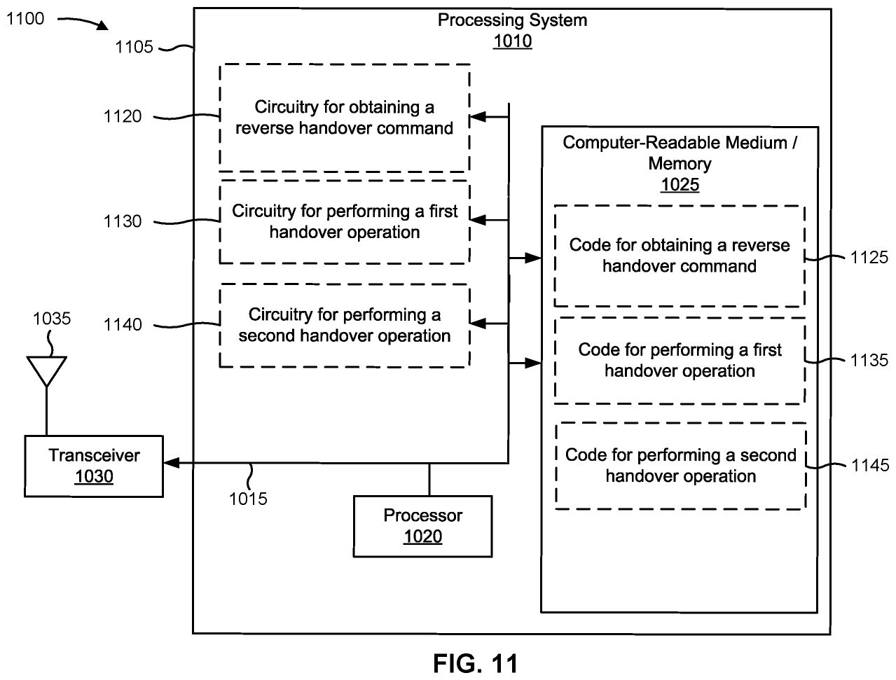

FIG. 11 is a diagram illustrating an example 1100 of an implementation of code and circuitry for an apparatus 1105, in accordance with the present disclosure. The apparatus 1105 may be a UE, or a UE may include the apparatus 1105.

As shown in FIG. 11, the apparatus 1105 may include circuitry for obtaining a reverse handover command (circuitry 1120). For example, the circuitry 1120 may enable the apparatus 1105 to obtain, from a first network node via a source cell, a reverse handover command associated with a second handover operation for handing over the UE from a first target cell to a second target cell.

As shown in FIG. 11, the apparatus 1105 may include, stored in computer-readable medium 1025, code for obtaining a reverse handover command (code 1125). For example, the code 1125, when executed by processor 1020, may cause processor 1020 to cause transceiver 1030 to obtain, from a first network node via a source cell, a reverse handover command associated with a second handover operation for handing over the UE from a first target cell to a second target cell.

As shown in FIG. 11, the apparatus 1105 may include circuitry for performing a first handover operation (circuitry 1130). For example, the circuitry 1130 may enable the apparatus 1105 to perform a first handover operation to hand over the UE from the source cell to the first target cell.

As shown in FIG. 11, the apparatus 1105 may include, stored in computer-readable medium 1025, code for performing a first handover operation (code 1135). For example, the code 1135, when executed by processor 1020, may cause processor 1020 to cause transceiver 1030 to perform a first handover operation to hand over the UE from the source cell to the first target cell.

As shown in FIG. 11, the apparatus 1105 may include circuitry for performing the second handover operation (circuitry 1140). For example, the circuitry 1140 may enable the apparatus 1105 to perform the second handover operation to hand over the UE from the first target cell to the second target cell.

As shown in FIG. 11, the apparatus 1105 may include, stored in computer-readable medium 1025, code for performing the second handover operation (code 1145). For example, the code 1145, when executed by processor 1020, may cause processor 1020 to cause transceiver 1030 to perform the second handover operation to hand over the UE from the first target cell to the second target cell.

FIG. 11 is provided as an example. Other examples may differ from what is described in connection with FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150.

In some aspects, the apparatus 1200 may be configured to perform one or more operations described herein in connection with FIGS. 5A-5B. Additionally, or alternatively, the apparatus 1200 may be configured to perform one or more processes described herein, such as process 700 of FIG. 7, process 800 of FIG. 8, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for obtaining, providing, transmitting, receiving, determining, activating, admitting, generating, encapsulating, and/or performing may include various processing system components, such as a receive processor, a transmit processor, a controller/processor, a memory, or a combination thereof, of the network node described above in connection with FIG. 2.

In some aspects, the communication manager 1208 may include one or more antennas, a modem, a controller/processor, a memory, or a combination thereof, of the network node described in connection with FIG. 2. In some aspects, the communication manager 1208 may include the reception component 1202 and/or the transmission component 1204. In some aspects, the communication manager 1208 may be, be similar to, include, or be included in, the communication manager 150 depicted in FIGS. 1 and 2.

The communication manager 1208 and/or the transmission component 1204 may provide, to a second network node, a first handover request message associated with a first handover operation for handing over a UE from a source cell to a first target cell, the first handover request message including a reverse handover indication associated with a second handover operation for handing over the UE from the first target cell to a second target cell. The communication manager 1208 and/or the reception component 1202 may obtain, from the UE, an access communication associated with the second handover operation.

The communication manager 1208 and/or the reception component 1202 may obtain, from the second network node, a handover request acknowledgment message comprising a suggested admitted service time associated with connection, by the UE, to the first target cell. The communication manager 1208 may activate an NES mode based on a duration associated with an admitted service time associated with connection, by the UE, to the first target cell. The communication manager 1208 and/or the transmission component 1204 may provide a modification request message to the second network node, the modification request message indicating at least one of a modification of an admitted service time associated with connection, by the UE, to the first target cell, or a cancellation of the second handover operation. The communication manager 1208 and/or the transmission component 1204 may provide to the second network node, a second request message associated with the second handover operation, wherein the second request message indicates the UE ID. The communication manager 1208 and/or the transmission component 1204 may provide to the UE, a reverse handover command associated with the second handover operation. The communication manager 1208 and/or the transmission component 1204 may provide to the UE, configuration information comprising a first configuration associated with the first target cell and a second configuration associated with the second target cell. The communication manager 1208 and/or the transmission component 1204 may provide a lower-layer trigger message associated with the first handover operation and the second handover operation. The communication manager 1208 and/or the transmission component 1204 may provide from the first network node, a CHO condition configuration that indicates a trigger condition for triggering the CHO operation.

The communication manager 1208 and/or the reception component 1202 may obtain, from a first network node, a first handover request message associated with a first handover operation for handing over a UE from a source cell to a first target cell, the first handover request message including a reverse handover indication associated with a second handover operation for handing over the UE from the first target cell to a second target cell. The communication manager 1208 and/or the reception component 1202 may obtain, from the UE, an access communication associated with the first handover operation. The communication manager 1208 and/or the transmission component 1204 may provide to the first network node, a handover request acknowledgment message comprising a suggested admitted service time associated with connection, by the UE, to the first target cell. The communication manager 1208 and/or the reception component 1202 may obtain, from the first network node, a modification request message indicating at least one of a modification of an admitted service time associated with connection, by the UE, to the first target cell, or a cancellation of the second handover operation. The communication manager 1208 and/or the transmission component 1204 may provide via a CU of the second network node to a DU of the second network node, the reverse handover indication; admitting, via the DU, the UE based on the reverse handover indication.

The communication manager 1208 and/or the reception component 1202 may obtain, from the first network node, a second request message associated with the second handover operation, wherein the second request message indicates the UE ID. The communication component 1208 and/or the transmission component 1204 may provide, to the UE, a lower-layer trigger message associated with the second handover operation. The communication manager 1208, the reception component 1202, and/or the transmission component 1204 may admit the first handover operation. The communication manager 1208 may generate a first handover command associated with the first handover operation, wherein the first handover command comprises an RRC configuration. The communication manager 1208 and/or the transmission component 1204 may provide the first handover command to the first network node, wherein the first handover command includes the CHO configuration. The communication manager 1208 and/or the transmission component 1204 may encapsulate the CHO configuration within the RRC configuration. The communication manager 1208 and/or the transmission component 1204 may provide to the first network node, an indication of an alteration of at least one trigger condition indicated by a CHO condition configuration. The communication manager 1208 may generate a CHO condition configuration that indicates a trigger condition for triggering the CHO operation. The communication manager 1208 and/or the reception component 1202 may obtain, from the first network node, a timing associated with the second handover operation, wherein generating the CHO condition configuration comprises generating the CHO condition configuration based on the timing.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

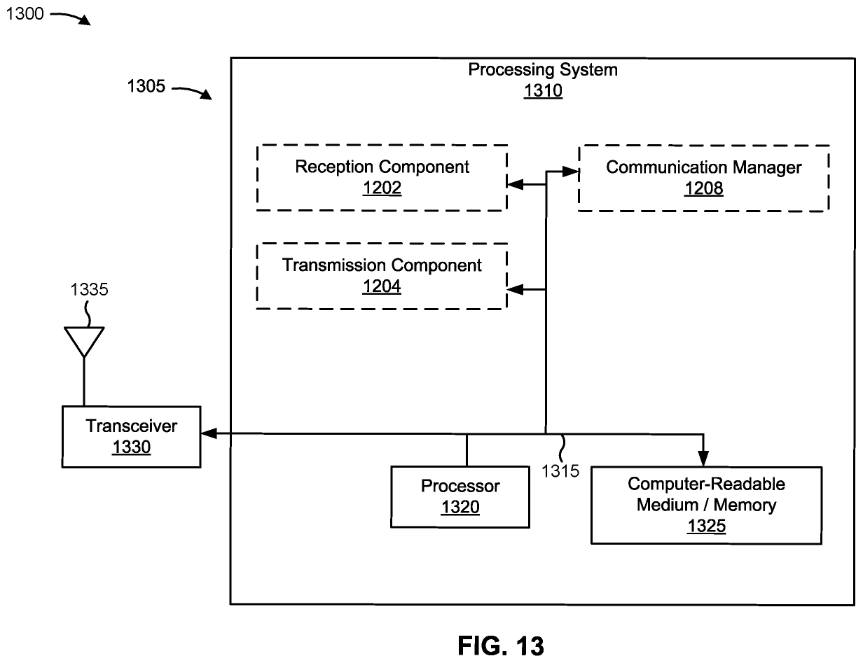

FIG. 13 is a diagram illustrating an example 1300 of a hardware implementation for an apparatus 1305 employing a processing system 1310, in accordance with the present disclosure. The apparatus 1305 may be a network node.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 130 and may include the memory 282 and/or at least one of the TX MIMO processor 266, the RX processor 258, and/or the controller/processor 280. In some aspects, the apparatus 1200 may include means for providing, to a second network node, a first handover request message associated with a first handover operation for handing over a UE from a source cell to a first target cell, the first handover request message including a reverse handover indication associated with a second handover operation for handing over the UE from the first target cell to a second target cell; and obtaining, from the UE, an access communication associated with the second handover operation. In some aspects, the apparatus 1200 may include means for obtaining, from a first network node, a first handover request message associated with a first handover operation for handing over a UE from a source cell to a first target cell, the first handover request message including a reverse handover indication associated with a second handover operation for handing over the UE from the first target cell to a second target cell; and obtaining, from the UE, an access communication associated with the first handover operation. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 13 is provided as an example. Other examples may differ from what is described in connection with FIG. 13.

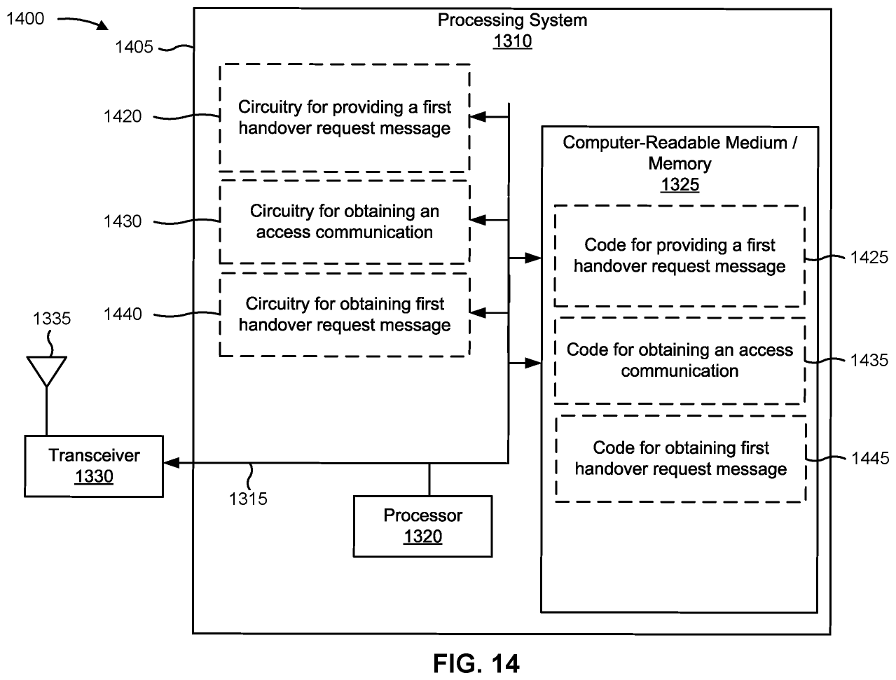

FIG. 14 is a diagram illustrating an example 1400 of an implementation of code and circuitry for an apparatus 1405, in accordance with the present disclosure. The apparatus 1405 may be a network node, or a network node may include the apparatus 1405.

As shown in FIG. 14, the apparatus 1405 may include circuitry for providing a first handover request message (circuitry 1420). For example, the circuitry 1420 may enable the apparatus 1405 to provide, to a second network node, a first handover request message associated with a first handover operation for handing over a UE from a source cell to a first target cell, the first handover request message including a reverse handover indication associated with a second handover operation for handing over the UE from the first target cell to a second target cell.

As shown in FIG. 14, the apparatus 1405 may include, stored in computer-readable medium 1325, code for providing a first handover request message (code 1425). For example, the code 1425, when executed by processor 1320, may cause processor 1320 to cause transceiver 1330 to provide, to a second network node, a first handover request message associated with a first handover operation for handing over a UE from a source cell to a first target cell, the first handover request message including a reverse handover indication associated with a second handover operation for handing over the UE from the first target cell to a second target cell.

As shown in FIG. 14, the apparatus 1405 may include circuitry for obtaining an access communication (circuitry 1430). For example, the circuitry 1430 may enable the apparatus 1405 to obtain, from the UE, an access communication associated with the second handover operation.

As shown in FIG. 14, the apparatus 1405 may include, stored in computer-readable medium 1325, code for obtaining an access communication (code 1435). For example, the code 1435, when executed by processor 1320, may cause processor 1320 to cause transceiver 1330 to obtain, from the UE, an access communication associated with the second handover operation.

As shown in FIG. 14, the apparatus 1405 may include circuitry for obtaining a first handover request message (circuitry 1440). For example, the circuitry 1440 may enable the apparatus 1405 to obtain, from the UE, an access communication associated with the second handover operation.

As shown in FIG. 14, the apparatus 1405 may include, stored in computer-readable medium 1325, code for obtaining a first handover request message (code 1445). For example, the code 1445, when executed by processor 1320, may cause processor 1320 to cause transceiver 1330 to obtain, from a first network node, a first handover request message associated with a first handover operation for handing over a UE from a source cell to a first target cell, the first handover request message including a reverse handover indication associated with a second handover operation for handing over the UE from the first target cell to a second target cell.

FIG. 14 is provided as an example. Other examples may differ from what is described in connection with FIG. 14.

The following provides an overview of some Aspects of the present disclosure:

Aspect 1: A method of wireless communication performed by a user equipment (UE), comprising: obtaining, from a first network node via a source cell, a reverse handover command associated with a second handover operation to hand over the UE from a first target cell to a second target cell; performing a first handover operation to hand over the UE from the source cell to the first target cell; and performing the second handover operation to hand over the UE from the first target cell to the second target cell.

Aspect 2: The method of Aspect 1, wherein the second target cell comprises the source cell.

Aspect 3: The method of either of Aspects 1 or 2, further comprising obtaining, from the first network node, configuration information comprising a first configuration associated with the first target cell and a second configuration associated with the second target cell.

Aspect 4: The method of Aspect 3, wherein the first configuration comprises a first radio resource control (RRC) configuration and the second configuration comprises a second RRC configuration.

Aspect 5: The method of either of Aspects 3 or 4, further comprising obtaining a lower-layer trigger message associated with the first handover operation and the second handover operation, wherein performing the first handover operation comprises performing a first lower-layer triggered mobility (LTM) handover operation based on obtaining the lower-layer trigger message.

Aspect 6: The method of Aspect 5, wherein performing the second handover operation comprises performing a second LTM handover operation based on obtaining the lower-layer trigger message.

Aspect 7: The method of Aspect 6, wherein the lower-layer trigger message comprises an LTM medium access control (MAC) control element (MAC CE).

Aspect 8: The method of either of Aspects 6 or 7, wherein the lower-layer trigger message comprises an indication of a minimum admitted service time associated with a connection between the UE and the first target cell prior to performance of the second handover operation.

Aspect 9: The method of any of Aspects 6-8, wherein the configuration information comprises an indication of a minimum admitted service time associated with a connection between the UE and the first target cell prior to performance of the second LTM handover operation.

Aspect 10: The method of any of Aspects 6-9, wherein the lower-layer trigger message indicates an associated logical channel identifier (ID) associated with at least one of the first LTM configuration or the second LTM configuration.

Aspect 11: The method of any of Aspects 6-10, wherein the lower-layer trigger message indicates at least one of the first LTM configuration or the second LTM configuration.

Aspect 12: The method of Aspect 3, wherein the configuration information comprises a conditional handover (CHO) configuration, and wherein performing the second handover operation comprises performing a CHO operation associated with the conditional CHO configuration.

Aspect 13: The method of Aspect 12, further comprising maintaining the CHO configuration after performing the first handover operation.

Aspect 14: The method of Aspect 13, wherein maintaining the CHO configuration comprises maintaining the CHO configuration based on obtaining the CHO configuration while connected to the source cell.

Aspect 15: The method of either of Aspects 13 or 14, wherein the configuration information includes a flag associated with maintaining the CHO configuration, wherein maintaining the CHO configuration comprises maintaining the CHO configuration based on the configuration information including the flag.

Aspect 16: The method of any of Aspects 12-15, wherein the configuration information further comprises a CHO condition configuration that indicates a trigger condition for triggering the CHO operation.

Aspect 17: The method of Aspect 16, wherein the trigger condition comprises at least one of a channel condition associated with a communication channel between the UE and the first target cell or a communication channel between the UE and the second target cell.

Aspect 18: The method of either of claim 16 or 17, wherein the trigger condition comprises a timer value associated with a triggering timer, wherein performing the CHO operation comprises performing the CHO operation based on an expiry of the triggering timer.

Aspect 19: The method of Aspect 18, wherein the timer value comprises an absolute time.

Aspect 20: The method of Aspect 18, wherein the timer value comprises a countdown value associated with a reference time.

Aspect 21: The method of Aspect 20, wherein the reference time comprises a time associated with obtaining the configuration information.

Aspect 22: The method of Aspect 20, wherein the reference time comprises a time of completion of the first handover operation.

Aspect 23: The method of Aspect 18, wherein the timer value corresponds to a duration of a network energy savings mode associated with the source cell.

Aspect 24: The method of any of Aspects 12-23, wherein obtaining the configuration information comprises obtaining a configuration message that includes the CHO configuration and a handover command associated with the first handover operation.

Aspect 25: The method of any of Aspects 3-24, wherein the configuration information comprises a flag that indicates at least one of an association between the first configuration and the first handover operation or an association between the second configuration and the second handover operation.

Aspect 26: The method of any of Aspects 3-25, wherein the first configuration comprises a handover command associated with the first handover operation and wherein the second configuration comprises a conditional handover (CHO) configuration, wherein the handover command comprises the CHO configuration and wherein performing the second handover operation comprises performing a CHO operation associated with the CHO configuration.

Aspect 27: The method of Aspect 26, wherein the handover command comprises a radio resource control (RRC) configuration, wherein the CHO configuration is encapsulated within the RRC configuration.

Aspect 28: The method of either of claim 26 or 27, further comprising obtaining, from the first network node, a CHO condition configuration that indicates a trigger condition for triggering the CHO operation.

Aspect 29: The method of any of Aspects 1-28, further comprising: obtaining, from the first network node, at least one reference signal associated with the second target cell; and providing, to a second network node, a measurement report including one or more measurements associated with the at least one reference signal; wherein performing the second handover operation comprises performing the second handover operation based on the one or more measurements.

Aspect 30: A method of wireless communication performed by a first network node, comprising: providing, to a second network node, a first handover request message associated with a first handover operation to hand over a user equipment (UE) from a source cell to a first target cell, the first handover request message including a reverse handover indication associated with a second handover operation to hand over the UE from the first target cell to a second target cell; and obtaining, from the UE, an access communication associated with the second handover operation.

Aspect 31: The method of Aspect 30, wherein the second target cell comprises the source cell.

Aspect 32: The method of either of claim 30 or 31, wherein the second target cell comprises a serving cell, other than the source cell, associated with the first network node.

Aspect 33: The method of any of Aspects 30-32, wherein the reverse handover indication comprises a duration indication indicative of a duration associated with an admitted service time associated with a connection between the UE and the first target cell prior to performance of the second handover operation.

Aspect 34: The method of any of Aspects 30-33, wherein the reverse handover indication comprises a timing indication indicative of a time range within which the second handover operation is to be performed.

Aspect 35: The method of any of Aspects 30-34, wherein the reverse handover indication comprises a cell identifier (ID) associated with the second target cell.

Aspect 36: The method of any of Aspects 30-35, further comprising obtaining, from the second network node, a handover request acknowledgment message comprising a suggested admitted service time associated with a connection between the UE and the first target cell.

Aspect 37: The method of any of Aspects 30-36, further comprising activating a network energy savings (NES) mode based on a duration associated with an admitted service time associated with a connection between the UE and the first target cell.

Aspect 38: The method of any of Aspects 30-37, further comprising providing a modification request message to the second network node, the modification request message indicating at least one of a modification of an admitted service time associated with a connection between the UE and the first target cell, or a cancellation of the second handover operation.

Aspect 39: The method of any of Aspects 30-38, wherein the reverse handover indication comprises an indication of a UE identifier (ID) corresponding to the UE.

Aspect 40: The method of Aspect 39, wherein the UE ID comprises an Xn application protocol (XnAP) UE ID.

Aspect 41: The method of either of claim 39 or 40, wherein at least one of the first handover request message or a context release message comprises an indication to maintain the UE ID.

Aspect 42: The method of any of Aspects 39-41, further comprising providing, to the second network node, a second request message associated with the second handover operation, wherein the second request message indicates the UE ID.

Aspect 43: The method of Aspect 42, wherein the second request message indicates a cell ID corresponding to the second target cell.

Aspect 44: The method of any of Aspects 30-43, further comprising providing, to the UE, a reverse handover command associated with the second handover operation.

Aspect 45: The method of any of Aspects 30-44, further comprising providing, to the UE, configuration information comprising a first configuration associated with the first target cell and a second configuration associated with the second target cell.

Aspect 46: The method of Aspect 45, wherein the first configuration comprises a first radio resource control (RRC) configuration and the second configuration comprises a second RRC configuration.

Aspect 47: The method of either of claim 45 or 46, wherein the method further comprises providing a lower-layer trigger message associated with the first handover operation and the second handover operation.

Aspect 48: The method of Aspect 47, wherein the lower-layer trigger message comprises an lower-layer triggered mobility (LTM) medium access control (MAC) control element (MAC CE).

Aspect 49: The method of either of Aspects 47 or 48, wherein the lower-layer trigger message comprises an indication of a minimum admitted service time associated with connection, by the UE, to the first target cell prior to performance of the second handover operation.

Aspect 50: The method of any of Aspects 47-49, wherein the configuration information comprises an indication of a minimum admitted service time associated with connection, by the UE, to the first target cell prior to performance of the second handover operation.

Aspect 51: The method of any of Aspects 47-50, wherein the lower-layer trigger message indicates an associated logical channel identifier (ID) associated with at least one of the first configuration or the second configuration.

Aspect 52: The method of any of Aspects 47-51, wherein the lower-layer trigger message indicates at least one of the first configuration or the second configuration.

Aspect 53: The method of any of Aspects 45-52, wherein the second configuration comprises a conditional handover (CHO) configuration, and wherein performing the second handover operation comprises performing a CHO operation associated with the conditional CHO configuration.

Aspect 54: The method of Aspect 53, wherein the configuration information includes a flag associated with maintaining the CHO configuration.

Aspect 55: The method of either of claim 53 or 54, wherein the configuration information further comprises a CHO condition configuration that indicates a trigger condition for triggering the CHO operation.

Aspect 56: The method of Aspect 55, wherein the trigger condition comprises at least one of a channel condition associated with a communication channel between the UE and the first target cell or a channel condition associated with a communication channel between the UE and the second target cell.

Aspect 57: The method of either or Aspects 55 or 56, wherein the trigger condition comprises a timer value associated with a triggering timer for the CHO operation.

Aspect 58: The method of Aspect 57, wherein the timer value comprises an absolute time.

Aspect 59: The method of Aspect 57, wherein the timer value comprises a countdown value associated with a reference time.

Aspect 60: The method of Aspect 59, wherein the reference time comprises a time associated with obtaining the configuration information.

Aspect 61: The method of Aspect 59, wherein the reference time comprises a time of completion of the first handover operation.

Aspect 62: The method of Aspect 57, wherein the timer value corresponds to a duration of a network energy savings mode associated with the source cell.

Aspect 63: The method of any of Aspects 55-62, wherein providing the configuration information comprises providing a configuration message that includes the CHO configuration and a handover command associated with the first handover operation.

Aspect 64: The method of any of Aspects 45-63, wherein the configuration information comprises a flag that indicates at least one of an association between the first configuration and the first handover operation or an association between the second configuration and the second handover operation.

Aspect 65: The method of any of Aspects 45-64, wherein the first configuration comprises a handover command associated with the first handover operation, wherein the second configuration comprises a conditional handover (CHO) configuration, and wherein the handover command comprises the CHO configuration, and wherein the second handover operation comprises a CHO operation associated with the CHO configuration.

Aspect 66: The method of Aspect 65, wherein the handover command comprises a radio resource control (RRC) configuration, wherein the CHO configuration is encapsulated within the RRC configuration.

Aspect 67: The method of either of claim 65 or 70, further comprising providing, from the first network node, a CHO condition configuration that indicates a trigger condition for triggering the CHO operation.

Aspect 68: The method of any of Aspects 30-67, wherein the reverse handover indication comprises a conditional handover (CHO) configuration associated with the second handover operation.

Aspect 69: A method of wireless communication performed by a second network node, comprising: obtaining, from a first network node, a first handover request message associated with a first handover operation to hand over a user equipment (UE) from a source cell to a first target cell, the first handover request message including a reverse handover indication associated with a second handover operation to hand over the UE from the first target cell to a second target cell; and obtaining, from the UE, an access communication associated with the first handover operation.

Aspect 70: The method of Aspect 69, wherein the second target cell comprises the source cell.

Aspect 71: The method of either of claim 69 or 70, wherein the second target cell comprises a serving cell, other than the source cell, associated with the first network node.

Aspect 72: The method of any of Aspects 69-71, wherein the reverse handover indication comprises a duration indication indicative of a duration associated with an admitted service time associated with a connection between the UE and the first target cell prior to performance of the second handover operation.

Aspect 73: The method of any of Aspects 69-72, wherein the reverse handover indication comprises a timing indication indicative of a time range within which the second handover operation is to be performed.

Aspect 74: The method of any of Aspects 69-73, wherein the reverse handover indication comprises a cell identifier (ID) associated with the second target cell.

Aspect 75: The method of any of Aspects 69-74, further comprising providing, to the first network node, a handover request acknowledgment message comprising a suggested admitted service time associated with a connection between the UE and the first target cell.

Aspect 76: The method of any of Aspects 69-75, further comprising obtaining, from the first network node, a modification request message indicating at least one of a modification of an admitted service time associated with a connection between the UE and the first target cell, or a cancellation of the second handover operation.

Aspect 77: The method of any of Aspects 69-76, further comprising: providing, via a central unit (CU) of the second network node to a distributed unit (DU) of the second network node, the reverse handover indication; admitting, via the DU, the UE based on the reverse handover indication; and providing, via the CU to the first network node, a handover request acknowledgment message based on admitting the UE.

Aspect 78: The method of any of Aspects 69-77, wherein the reverse handover indication comprises an indication of a UE ID corresponding to the UE.

Aspect 79: The method of Aspect 78, wherein the UE ID comprises an Xn application protocol (XnAP) UE ID.

Aspect 80: The method of either of claim 78 or 79, wherein at least one of the first handover request message or a context release message comprises an indication to maintain the UE ID.

Aspect 81: The method of any of Aspects 78-80, further comprising obtaining, from the first network node, a second request message associated with the second handover operation, wherein the second request message indicates the UE ID.

Aspect 82: The method of Aspect 81, wherein the second request message indicates a cell ID corresponding to the second target cell.

Aspect 83: The method of any of Aspects 69-82, further comprising providing, to the UE, a lower-layer trigger message associated with the second handover operation.

Aspect 84: The method of Aspect 83, wherein the lower-layer trigger message comprises a lower-layer triggered mobility (LTM) medium access control (MAC) control element (MAC CE).

Aspect 85: The method of any of Aspects 69-84, wherein the first handover request message comprises a second configuration associated with the second handover operation, the second configuration comprising a conditional handover (CHO) configuration for a CHO operation, the method further comprising: admitting the first handover operation; generating a first handover command associated with the first handover operation, wherein the first handover command comprises a radio resource control (RRC) configuration; and providing the first handover command to the first network node, wherein the first handover command includes the CHO configuration.

Aspect 86: The method of Aspect 85, further comprising encapsulating the CHO configuration within the RRC configuration.

Aspect 87: The method of either of claim 85 or 86, further comprising providing, to the first network node, an indication of an alteration of at least one trigger condition indicated by a CHO condition configuration.

Aspect 88: The method of any of Aspects 85-87, further comprising generating a CHO condition configuration that indicates a trigger condition for triggering the CHO operation.

Aspect 89: The method of Aspect 88, wherein the CHO configuration includes the CHO condition configuration.

Aspect 90: The method of either of claim 88 or 89, further comprising obtaining, from the first network node, a timing associated with the second handover operation, wherein generating the CHO condition configuration comprises generating the CHO condition configuration based on the timing.

Aspect 91: The method of any of Aspects 69-90, wherein the reverse handover indication comprises a conditional handover (CHO) configuration associated with the second handover operation.

Aspect 92: The method of any of Aspects 1-29, wherein the first handover operation comprises a regular handover operation.

Aspect 93: The method of any of Aspects 1-29, wherein the first handover operation comprises a conditional handover operation.

Aspect 94: The method of any of Aspects 1-29, wherein the source cell is associated with a cell discontinuous transmission and/or discontinuous reception (DTX/DRX) configuration.

Aspect 95, The method of Aspect 94, wherein performing the first handover operation comprises performing the first handover operation in association with the cell DTX/DRX operation.

Aspect 96: The method of Aspect 94, wherein performing the second handover operation comprises performing the second handover operation based on a cell DTX/DRX cycle associated with the cell DTX/DRX configuration.

Aspect 97: The method of Aspect 94, further comprising obtaining information associated with the cell DTX/DRX configuration, wherein performing the second handover operation comprises performing the second handover operation based on the information associated with the cell DTX/DRX configuration.

Aspect 98: The method of Aspect 94, wherein performing the second handover operation comprises performing the second handover operation based on activation, associated with the first target cell, of a reception active duration of a DTX/DRX cycle associated with a DTX/DRX configuration associated with the first target cell.

Aspect 99: The method of any of Aspects 30-68, wherein the source cell is associated with a cell discontinuous transmission and/or discontinuous reception (DTX/DRX) configuration.

Aspect 100, The method of Aspect 99, wherein the first handover operation is associated with the cell DTX/DRX operation.

Aspect 101: The method of Aspect 99, further comprising performing the second handover operation based on a cell DTX/DRX cycle associated with the cell DTX/DRX configuration.

Aspect 102: The method of Aspect 99, further comprising providing information associated with the cell DTX/DRX configuration; and performing the second handover operation based on the information associated with the cell DTX/DRX configuration.

Aspect 103: The method of Aspect 99, further comprising performing the second handover operation based on activation, associated with the first target cell, of a reception active duration of a DTX/DRX cycle associated with a DTX/DRX configuration associated with the first target cell.

Aspect 104: The method of any of Aspects 69-91, wherein the source cell is associated with a cell discontinuous transmission and/or discontinuous reception (DTX/DRX) configuration.

Aspect 105, The method of Aspect 104, wherein the first handover operation is associated with the cell DTX/DRX operation.

Aspect 106: The method of Aspect 104, further comprising performing the second handover operation based on a cell DTX/DRX cycle associated with the cell DTX/DRX configuration.

Aspect 107: The method of Aspect 104, further comprising obtaining information associated with the cell DTX/DRX configuration; and performing the second handover operation based on the information associated with the cell DTX/DRX configuration.

Aspect 108: The method of Aspect 104, further comprising performing the second handover operation based on activation, associated with the first target cell, of a reception active duration of a DTX/DRX cycle associated with a DTX/DRX configuration associated with the first target cell.

Aspect 109: An apparatus for wireless communication at a device, comprising a processor; memory coupled with the processor; and instructions stored in the memory and executable by the processor to cause the apparatus to perform the method of one or more of Aspects 1-29 or 94-98.

Aspect 110: A device for wireless communication, comprising a memory and one or more processors coupled to the memory, the one or more processors configured to perform the method of one or more of Aspects 1-29 or 94-98.

Aspect 111: An apparatus for wireless communication, comprising at least one means for performing the method of one or more of Aspects 1-29 or 94-98.

Aspect 112: A non-transitory computer-readable medium storing code for wireless communication, the code comprising instructions executable by a processor to perform the method of one or more of Aspects 1-29 or 94-98.

Aspect 113: A non-transitory computer-readable medium storing a set of instructions for wireless communication, the set of instructions comprising one or more instructions that, when executed by one or more processors of a device, cause the device to perform the method of one or more of Aspects 1-29 or 94-98.

Aspect 114: An apparatus for wireless communication at a device, comprising a processor; memory coupled with the processor; and instructions stored in the memory and executable by the processor to cause the apparatus to perform the method of one or more of Aspects 30-68 or 99-103.

Aspect 115: A device for wireless communication, comprising a memory and one or more processors coupled to the memory, the one or more processors configured to perform the method of one or more of Aspects 30-68 or 99-103.

Aspect 116: An apparatus for wireless communication, comprising at least one means for performing the method of one or more of Aspects 30-68 or 99-103.

Aspect 117: A non-transitory computer-readable medium storing code for wireless communication, the code comprising instructions executable by a processor to perform the method of one or more of Aspects 30-68 or 99-103.

Aspect 118: A non-transitory computer-readable medium storing a set of instructions for wireless communication, the set of instructions comprising one or more instructions that, when executed by one or more processors of a device, cause the device to perform the method of one or more of Aspects 30-68 or 99-103.

Aspect 119: An apparatus for wireless communication at a device, comprising a processor; memory coupled with the processor; and instructions stored in the memory and executable by the processor to cause the apparatus to perform the method of one or more of Aspects 69-91 or 104-108.

Aspect 120: A device for wireless communication, comprising a memory and one or more processors coupled to the memory, the one or more processors configured to perform the method of one or more of Aspects 69-91 or 104-108.

Aspect 121: An apparatus for wireless communication, comprising at least one means for performing the method of one or more of Aspects 69-91 or 104-108.

Aspect 122: A non-transitory computer-readable medium storing code for wireless communication, the code comprising instructions executable by a processor to perform the method of one or more of Aspects 69-91 or 104-108.

Aspect 123: A non-transitory computer-readable medium storing a set of instructions for wireless communication, the set of instructions comprising one or more instructions that, when executed by one or more processors of a device, cause the device to perform the method of one or more of Aspects 69-91 or 104-108.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and individually or collectively configured to cause the UE to:
obtain, from a first network node via a source cell, a reverse handover command associated with a second handover operation associated with a first target cell;
perform a first handover operation to hand over the UE from the source cell to the first target cell; and
perform the second handover operation to hand over the UE from the first target cell to the second target cell.

2. The UE of claim 1, wherein the second target cell comprises the source cell.

3. The UE of claim 1, wherein the one or more processors are further individually or collectively configured to cause the UE to obtain, from the first network node, configuration information comprising a first configuration associated with the first target cell and a second configuration associated with the second target cell.

4. The UE of claim 3, wherein the first configuration comprises a first radio resource control (RRC) configuration and the second configuration comprises a second RRC configuration.

5. The UE of claim 3, wherein the one or more processors are further individually or collectively configured to cause the UE to obtain a lower-layer trigger message associated with the first handover operation and the second handover operation, wherein the one or more processors, to cause the UE to perform the first handover operation, are individually or collectively configured to cause the UE to perform a first lower-layer triggered mobility (LTM) handover operation based on the lower-layer trigger message.

6. The UE of claim 5, wherein the one or more processors, to cause the UE to perform the second handover operation, are individually or collectively configured to cause the UE to perform a second LTM handover operation based on the lower-layer trigger message.

7. The UE of claim 6, wherein the lower-layer trigger message comprises an LTM medium access control (MAC) control element (MAC CE).

8. The UE of claim 6, wherein the lower-layer trigger message comprises an indication of a minimum admitted service time associated with a connection between the UE and the first target cell prior to performance of the second handover operation.

9. The UE of claim 6, wherein the configuration information comprises an indication of a minimum admitted service time associated a connection between the UE and the first target cell prior to performance of the second LTM handover operation.

10. The UE of claim 6, wherein the lower-layer trigger message indicates an associated logical channel identifier (ID) associated with at least one of a first LTM configuration associated with the first LTM handover operation or a second LTM configuration associated with the second LTM handover operation.

11. The UE of claim 6, wherein the lower-layer trigger message indicates at least one of the first LTM configuration or the second LTM configuration.

12. The UE of claim 3, wherein the configuration information comprises a conditional handover (CHO) configuration, and wherein the one or more processors, to cause the UE to perform the second handover operation, are individually or collectively configured to cause the UE to perform a CHO operation associated with the conditional CHO configuration.

13. The UE of claim 12, wherein the one or more processors are further individually or collectively configured to cause the UE to maintain the CHO configuration after the first handover operation.

14. The UE of claim 13, wherein the one or more processors, to cause the UE to maintain the CHO configuration, are individually or collectively configured to cause the UE to maintain the CHO configuration based on obtaining the CHO configuration while connected to the source cell.

15. The UE of claim 13, wherein the configuration information includes a flag associated with maintaining the CHO configuration, wherein the one or more processors, to cause the UE to maintain the CHO configuration, are individually or collectively configured to cause the UE to maintain the CHO configuration based on the configuration information including the flag.

16. The UE of claim 12, wherein the configuration information further comprises a CHO condition configuration that indicates a trigger condition for triggering the CHO operation.

17. The UE of claim 16, wherein the trigger condition comprises at least one of a channel condition associated with a communication channel between the UE and the first target cell, a communication channel between the UE and the second target cell, or a timer value associated with a triggering timer, wherein the one or more processors, to cause the UE to perform the CHO operation, are individually or collectively configured to perform the CHO operation based on an expiry of the triggering timer.

18. The UE of claim 17, wherein the timer value corresponds to a duration of a network energy savings mode associated with the source cell.

19. The UE of claim 12, wherein the one or more processors, to cause the UE to obtain the configuration information, are individually or collectively configured to cause the UE to obtain a configuration message that includes the CHO configuration and a handover command associated with the first handover operation.

20. The UE of claim 3, wherein the configuration information comprises a flag that indicates at least one of an association between the first configuration and the first handover operation or an association between the second configuration and the second handover operation.

21. The UE of claim 3, wherein the first configuration comprises a handover command associated with the first handover operation and wherein the second configuration comprises a conditional handover (CHO) configuration, wherein the handover command comprises the CHO configuration and wherein the one or more processors, to cause the UE to perform the second handover operation, are individually or collectively configured to cause the UE to perform a CHO operation associated with the CHO configuration.

22. The UE of claim 21, wherein the one or more processors are further individually or collectively configured to cause the UE to obtain, from the first network node, a CHO condition configuration that indicates a trigger condition for triggering the CHO operation.

23. The UE of claim 1, wherein the one or more processors are further individually or collectively configured to cause the UE to:
obtain, from the first network node, at least one reference signal associated with the second target cell; and
provide, to a second network node, a measurement report including one or more measurements associated with the at least one reference signal;
wherein the one or more processors, to cause the UE to perform the second handover operation, are individually or collectively configured to cause the UE to perform the second handover operation based on the one or more measurements.

24. The UE of claim 1, wherein the source cell is associated with a cell discontinuous transmission and/or discontinuous reception (DTX/DRX) configuration, wherein the one or more processors, to cause the UE to perform the first handover operation, are configured to cause the UE to perform the first handover operation in association with the cell DTX/DRX configuration.

25. An apparatus for wireless communication at a first network node, comprising:
one or more memories; and
one or more processors coupled with the one or more memories and individually or collectively configured to cause the first network node to:
provide, to a second network node, a first handover request message associated with a first handover operation to hand over a user equipment (UE) from a source cell to a first target cell, the first handover request message including a reverse handover indication associated with a second handover operation to hand over the UE from the first target cell to a second target cell; and
obtain, from the UE, an access communication associated with the second handover operation.

26. The first network node of claim 25, wherein the second target cell comprises the source cell.

27. An apparatus for wireless communication at a second network node, comprising:
one or more memories; and
one or more processors coupled with the one or more memories and individually or collectively configured to cause the second network node to:
obtain, from a first network node, a first handover request message associated with a first handover operation to hand over a user equipment (UE) from a source cell to a first target cell, the first handover request message including a reverse handover indication associated with a second handover operation to hand over the UE from the first target cell to a second target cell; and
obtain, from the UE, an access communication associated with the first handover operation.

28. The second network node of claim 27, wherein the second target cell comprises the source cell.

29. A method of wireless communication performed by a user equipment (UE), comprising:
obtaining, from a first network node via a source cell, a reverse handover command associated with a second handover operation for handing over the UE from a first target cell to a second target cell;
performing a first handover operation to hand over the UE from the source cell to the first target cell; and
performing the second handover operation to hand over the UE from the first target cell to the second target cell.

30. The method of claim 29, wherein the second target cell comprises the source cell.
